(19) United States
(12) Patent Application Publication
(10) Pub. No.: US 2012/0023308 A1
(43) Pub. Date: Jan. 26, 2012

(54) PARALLEL COMPARISON/SELECTION OPERATION APPARATUS, PROCESSOR, AND PARALLEL COMPARISON/SELECTION OPERATION METHOD

(75) Inventors: Takahiro Kumura, Tokyo (JP); Hideki Matsuyama, Kanagawa (JP)

(73) Assignees: RENESAS ELECTRONICS CORPORATION, Kanagawa (JP); NEC CORPORATION, Tokyo (JP)

(21) Appl. No.: 13/147,157

(22) PCT Filed: Jan. 25, 2010
(86) PCT No.: PCT/JP2010/000398

§ 371 Date: Jul. 29, 2011

(30) Foreign Application Priority Data
Feb. 2, 2009 (JP) 2009-021199

(51) Int. Cl. G06F 9/30

(52) U.S. Cl. 712/7; 712/E09.023

(57) ABSTRACT

Provided is a parallel comparison/selection operation apparatus which efficiently executes a search for a maximum value or a search for a minimum value with an index. The parallel comparison/selection operation apparatus includes a vector comparison/selection unit 242 that compares each element included in vector data 1 and vector data 2 for each corresponding element using the vector data 1 and the vector data 2, selects one element of the vector data 1 and the vector data 2 based on the comparison result, and generates vector data 3 including the selected element, and an index vector selection unit 243 that selects one element of an index vector 1 and an index vector 2 based on the comparison result vector using the index vector 1 of the vector data 1, the index vector 2 of the vector data 2, and the comparison result vector to generate and output an index vector 3 including the selected element.

### TECHNICAL FIELD

The present invention relates to a Single Instruction Multiple Data (SIMD)-type parallel comparison/selection operation apparatus or a processor that is capable of searching a maximum value or a minimum value and its index with high speed.

### BACKGROUND ART

A SIMD instruction is an instruction to execute the same operation on a plurality of data items in parallel. A plurality of data items used for operation are typically stored in one register. Each of the plurality of data items stored in the register is called subword. The typical number of subwords stored in one register is 2^{N}. A representative SIMD instruction executes addition operation using four subwords stored in a register. The SIMD instruction is suitable for an application such as image processing, where a large number of data items can be processed in parallel.

Consider processing for searching the largest value or processing for searching the smallest value from a large number of data items. Non-patent literatures 1 and 2 disclose a processor including a SIMD instruction suitable for processing for searching the maximum value or the minimum value. For example, the instruction of VMAXSW of PowerPC (registered trademark) disclosed in Non-patent literature 2 compares elements positioned in the corresponding parts of two input vector data, selects the larger one, and outputs vector data including the selected element. However, the instruction like VMAXSW is of little use when searching the maximum value and its index, although it is convenient when only the maximum value should be searched.

In order to obtain the maximum value and its index from a large number of data items, (1) processing for comparing data with the current maximum value, (2) processing for replacing the current maximum value based on the comparison result, and (3) processing for replacing the current index based on the comparison result are repeatedly executed. Although the instruction like VMAXSW used in the related processor can execute processing (1) and (2), it cannot execute processing (3). Accordingly, the processor executes processing (1) to (3) by different instructions. As one example, the processor executes the processing (1) by the instruction A, the processing (2) by the instruction B, and the processing (3) by the instruction C.

For example, the processor called PowerPC uses the instruction of VCMPGTSW (see Non-patent literature 2) for the processing (1), and the instruction of VSEL for each of the processing (2) and (3). The instruction VCMPGTSW compares two pieces of vector data to output one of zero (0) and minus one (−1) according to the comparison result. The instruction VSEL selects one of the two pieces of vector data for every one bit based on the control information. When there is no instruction like VSEL, the processing equivalent to VSEL is executed using AND operation and OR operation. While described above is the processing example in PowerPC, the same thing can be applied to other related processors. In short, the problem in the related processors is that, since the processing (1) to (3) are executed by separate instructions, this increases the number of steps to execute the processing (1) to (3).

Patent literature 1 discloses a vector data retrieval apparatus that receives a series of vector data that are ordered, and retrieves and outputs the maximum value or the minimum value in the vector data and the element number corresponding to the maximum value or the minimum value. However, the technique disclosed in Patent literature 1 uses an operation unit that concurrently compares a plurality of elements, which requires the operation unit that corresponds to the number of inputs. When there are three or more inputs, a comparison operation unit having multiple inputs corresponding to the number of inputs needs to be used. The comparison operation unit having three or more multiple inputs delays processing compared to the comparison operation unit having two inputs.

### CITATION LIST

### Patent Literature

[Patent Literature 1]
Japanese Examined Patent Application Publication No. 8-33810

### Non Patent Literature

[Non-Patent Literature 1]
Freescale™ semiconductor, “AltiVec™ Technology Programming Environments Manual”, AltiVec Instructions, ALTIVECPEM, Rev.3, April, 2006, Page index 6-61 (173rd page from the top) of Chapter 6

[Non-Patent Literature 2]
Freescale™ semiconductor, “AltiVec™ Technology Programming Environments Manual”, AltiVec Instructions, ALTIVECPEM, Rev.3, April, 2006, Page index 6-75 (187th page from the top) of Chapter 6

### SUMMARY OF INVENTION

### Technical Problem

The problem of the related processors is that it is impossible to efficiently execute a search for a maximum value or a search for a minimum value with an index.

One object of the present invention is to provide a parallel comparison/selection operation apparatus and a parallel comparison/selection operation method capable of efficiently executing a search for a maximum value or a search for a minimum value with an index.

### Solution to Problem

An exemplary aspect of a parallel comparison/selection operation apparatus according to the present invention includes a vector comparison/selection unit that compares each element included in first vector data and second vector data for each corresponding element using the first vector data including a plurality of elements and second vector data including the same number of elements as the first vector data, selects one element of the first vector data and the second vector data based on the comparison result, and generates third vector data including the selected element; and an index vector selection unit that selects one element of a first index vector and a second index vector based on the comparison result using the first index vector including an index corresponding to each element included in the first vector data, the second index vector including an index corresponding to each element included in the second vector data, and the comparison result to generate a third index vector including the selected element.

Further, an exemplary aspect of a processor according to the present invention includes the parallel comparison/selection operation apparatus stated above.

Further, an exemplary aspect of a parallel comparison/selection operation method according to the present invention includes comparing each element included in first vector data and second vector data for each corresponding element using the first vector data including a plurality of elements, the second vector data including the same number of elements as the first vector data, first index information regarding an index of the first vector data, and a second index vector including an index corresponding to each element included in the second vector data; selecting one element of the first vector data and the second vector data based on the comparison result; generating third vector data including the selected element; selecting an index corresponding to each element included in the third vector data based on the comparison result, the first index information, and the second index vector; and generating a third index vector including selected plurality of indices.

### Advantageous Effects of Invention

According to the present invention, it is possible to efficiently execute a search for a maximum value or a search for a minimum value with an index.

### BRIEF DESCRIPTION OF DRAWINGS

FIG. 1 is a diagram showing a configuration of a processor according to a representative exemplary embodiment of the present invention;

FIG. 2 is a diagram showing a configuration example of a parallel comparison/selection operation unit according to a first exemplary embodiment of a processor;

FIG. 3 is a diagram showing a configuration example of a vector comparison/selection unit of the parallel comparison/selection operation unit shown in FIG. 2;

FIG. 4 is a diagram showing a configuration example of a dividing unit used in the parallel comparison/selection operation unit shown in FIG. 2;

FIG. 5 is a diagram showing a configuration example of a coupling unit used in the parallel comparison/selection operation unit shown in FIG. 2;

FIG. 6A is a diagram showing a configuration example of a comparison/selection unit used in the vector comparison/selection unit shown in FIG. 3;

FIG. 6B is a diagram showing an operation of a comparison unit of the comparison/selection unit shown in FIG. 6A;

FIG. 6C is a diagram showing an operation of a selection unit of the comparison/selection unit shown in FIG. 6A;

FIG. 7 is a diagram showing a configuration example of an index vector selection unit used in the parallel comparison/selection operation unit shown in FIG. 2 or a parallel comparison/selection operation unit shown in FIG. 15;

FIG. 8 is a diagram showing a concept of processing for searching a maximum value or a minimum value according to a representative exemplary embodiment of the present invention;

FIG. 9 is a diagram showing a flow chart to execute processing for searching the maximum value or the minimum value in the representative exemplary embodiment of the present invention based on the concept shown in FIG. 8;

FIG. 10 is a diagram showing specific processing contents of step 1 of the flow chart in FIG. 9 according to the first exemplary embodiment;

FIG. 11 is a diagram showing specific processing contents of step 5 of the flow chart in FIG. 9 according to the first exemplary embodiment;

FIG. 12 is a diagram showing instructions available for operating the parallel comparison/selection operation unit shown in FIG. 2 in the first exemplary embodiment;

FIG. 13 is a diagram showing a state in which the processor obtains the maximum value or the minimum value and its index from 16 pieces of 16-bit data in the first exemplary embodiment;

FIG. 14 is a diagram showing a specific processing example of step 6 of the flow chart shown in FIG. 9;

FIG. 15 is a diagram showing a configuration example of a parallel comparison operation unit according to a second exemplary embodiment of a processor;

FIG. 16A is a diagram showing a configuration example of an index vector generation unit used in the parallel comparison/selection operation unit shown in FIG. 15;

FIG. 16B is a diagram showing the meaning of a control signal of the index vector generation unit shown in FIG. 16A;

FIG. 17A is a diagram showing a configuration example of an update unit used in the parallel comparison/selection operation unit shown in FIG. 15;

FIG. 17B is a diagram showing a relation between step and a control signal of the update unit shown in FIG. 17A;

FIG. 18 is a diagram showing specific processing contents of step 1 of the flow chart in FIG. 9 according to the second exemplary embodiment;

FIG. 19 is a diagram showing specific processing contents of step 4 and step 5 of the flow chart in FIG. 9 according to the second exemplary embodiment;

FIG. 20 is a diagram showing instructions available for operating the parallel comparison/selection operation unit shown in FIG. 15 in the second exemplary embodiment; and

FIG. 21 is a diagram showing a state in which the processor obtains a maximum value or a minimum value and its index from 16 pieces of 16-bit data in the second exemplary embodiment.

### DESCRIPTION OF EMBODIMENTS

Hereinafter, exemplary embodiments of the present invention will be described with reference to the drawings. For the sake of simplification of description, the following description and drawings are omitted or simplified as appropriate. Throughout the drawings, the same reference symbols are given to the components and the corresponding parts having the same configurations or functions, and the description of which will be omitted.

In the following description, vector data is a set of a plurality of elements (data). Further, an index vector is a set of the number of each element (element number) included in the vector data. The number of an element (data) in the vector data is called index.

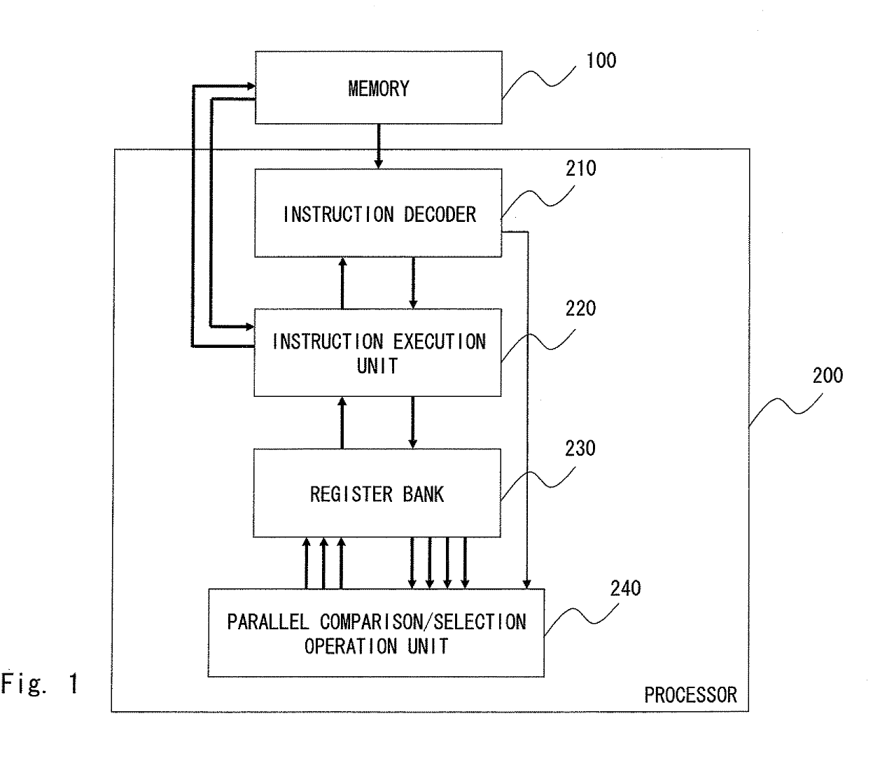

The exemplary embodiments of the present invention will be described with reference to the drawings. Referring to FIG. 1, a schematic exemplary embodiment of the present invention includes a processor 200 and a memory (storage unit) 100. The processor 200 includes an instruction decoder 210, an instruction execution unit 220, a register bank (temporary storage unit) 230, and a parallel comparison/selection operation unit (parallel comparison/selection operation apparatus) 240. The memory 100 stores a program or data for the processor 200. The program includes a plurality of instructions. The register bank 230 includes a plurality of registers. The register bank 230 also includes a program counter to store an address to read an instruction in the memory 100.

The instruction decoder 210 reads an instruction from the memory 100 using an address indicated by a program counter stored in the register bank 230 in synchronization with a clock signal, decodes its instruction, and transmits information including an output, an input operand, and an instruction code of the instruction to the instruction execution unit 220 or the parallel comparison/selection operation unit 240. Whether the instruction decoder 210 transmits the information to the instruction execution unit 220 or to the parallel comparison/selection operation unit 240 depends on instruction codes. When the instruction code indicates the operation to be executed in the parallel comparison/selection operation unit 240, the information including the instruction code is transmitted to the parallel comparison/selection operation unit 240. The instruction decoder 210 further adds the word length of the instruction to the program counter stored in the register bank 230.

The instruction execution unit 220 reads the contents of the input operand from the register bank 230 or the memory 100 based on the information including the operand and the instruction code supplied from the instruction decoder 210, executes the operation corresponding to the instruction code, and writes the operation result into the memory 100 or the register bank 230 which is the output operand.

The instruction decoder 210, the instruction execution unit 220, the register bank 230, and the memory 100 are components of a typical processor system except the parallel comparison/selection operation unit 240.

The parallel comparison/selection operation unit 240 executes comparison and selection regarding vector data and the corresponding index vector. The parallel comparison/selection operation unit 240 reads the vector data and the index vector that are input signals from the register bank 230. The data output from the parallel comparison/selection operation unit 240 is the vector data and the index vector, and the parallel comparison/selection operation unit 240 writes them into the register bank 230.

### First Exemplary Embodiment

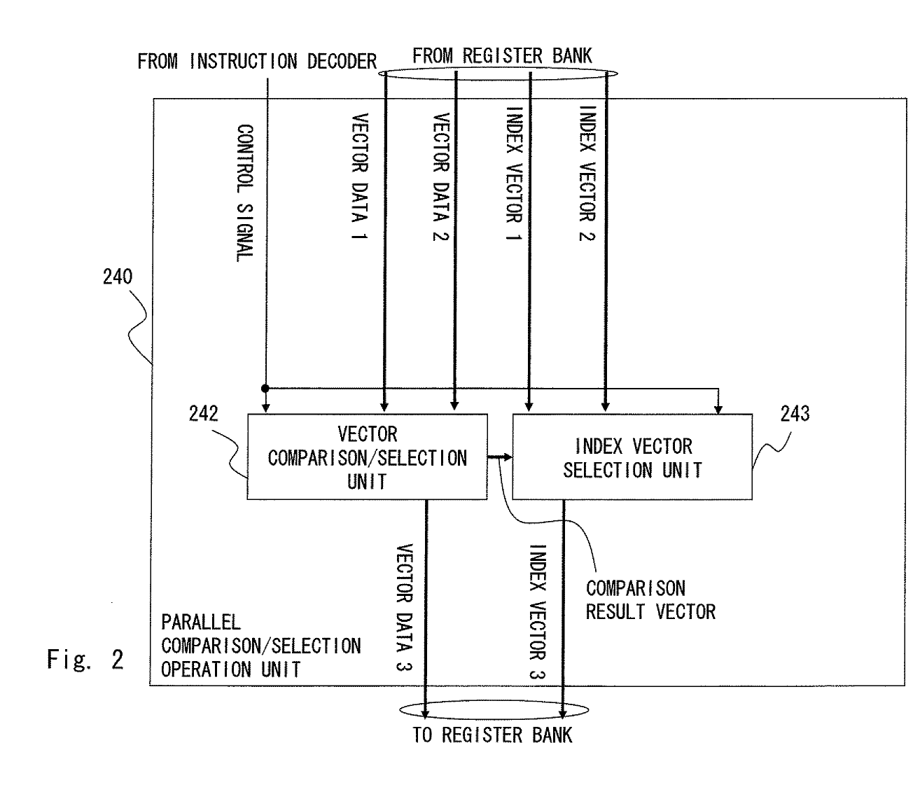

With reference to FIG. 2, the parallel comparison/selection operation unit 240 according to a first exemplary embodiment will be described. The parallel comparison/selection operation unit 240 according to the first exemplary embodiment includes a vector comparison/selection unit 242 and an index vector selection unit 243. The parallel comparison/selection operation unit 240 according to the first exemplary embodiment receives four pieces of data supplied from the register bank 230 and a control signal supplied from the instruction decoder 210. The four pieces of data include vector data 1 (first vector data), vector data 2 (second vector data), an index vector 1 (first index vector), and an index vector 2 (second index vector). The parallel comparison/selection operation unit 240 according to the first exemplary embodiment outputs vector data 3 (third vector data) and an index vector 3 (third index vector).

The vector comparison/selection unit 242 compares the vector data 1 with the vector data 2, and outputs the comparison result to the index vector selection unit 243 as a comparison result vector. Further, the vector comparison/selection unit 242 selects an appropriate element from the vector data 1 and the vector data 2 based on the comparison result, and outputs the selected element as the vector data 3.

The index vector selection unit 243 selects an appropriate element from the index vector 1 and the index vector 2 based on the comparison vector supplied from the vector comparison/selection unit 242, and outputs the selected element as the index vector 3.

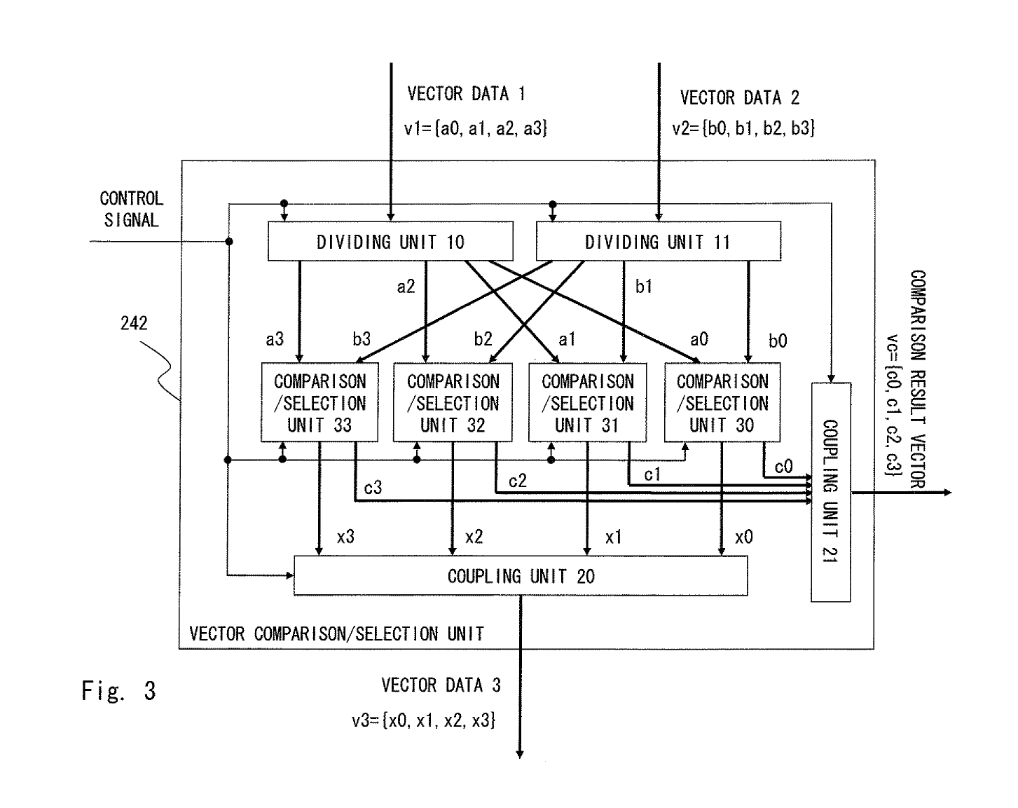

With reference to FIG. 3, the vector comparison/selection unit 242 will be described. The vector comparison/selection unit 242 includes two dividing units 10, 11, two coupling units 20, 21, and a plurality of comparison/selection units 30 to 33. FIG. 3 shows a case in which the number of comparison/selection units is four. The vector comparison/selection unit 242 receives a control signal output from the instruction decoder 210, the vector data 1 and the vector data 2 output from the register bank 230. The vector comparison/selection unit 242 outputs a comparison result vector and the vector data 3.

One dividing unit (first vector dividing unit) 10 receives the vector data 1, divides the vector data 1 into a plurality of elements based on the control signal, and outputs respective elements to the comparison/selection units 30 to 33. The control signal supplied to the dividing unit 10 represents a division number. Similarly, the other dividing unit (second vector dividing unit) 11 receives the vector data 2, divides the vector data 2 into a plurality of elements based on the control signal, and outputs respective elements to the comparison/selection units 30 to 33. In FIG. 3, the dividing unit 10 divides each of the vector data 1 and the vector data 2 into four elements, and transmits respective elements to the comparison/selection units 30 to 33.

The comparison/selection units 30 to 33 output comparison results c and selection elements x based on the control signal, the elements a supplied from one dividing unit 10, and the elements b supplied from the other dividing unit 11. In summary, each of the comparison/selection units 30 to 33 compares P-th (P is an integer of 0 or more) two elements of the vector data 1 and the vector data 2 based on the control signal. In FIG. 3, P matches the numerical values zero to three added to the elements a (a0 to a3) and the elements b (b0 to b3).

One coupling unit (vector coupling unit) 20 couples a plurality of selection elements x supplied from the comparison/selection units 30 to 33 to output the coupling result as the vector data 3. The other coupling unit (comparison result coupling unit) 20 couples a plurality of comparison results c supplied from the plurality of comparison/selection units 30 to 33 to output the coupling result as the comparison result vector. In FIG. 3, one coupling unit 20 couples the elements x0, x1, x2, and x3 supplied from the four comparison/selection units 30 to 33 to output the coupling result as the vector data 3; the other coupling unit 21 couples the comparison results c0, c1, c2, and c3 supplied from the four comparison/selection units 30 to 33 to output the coupling result as the comparison result vector.

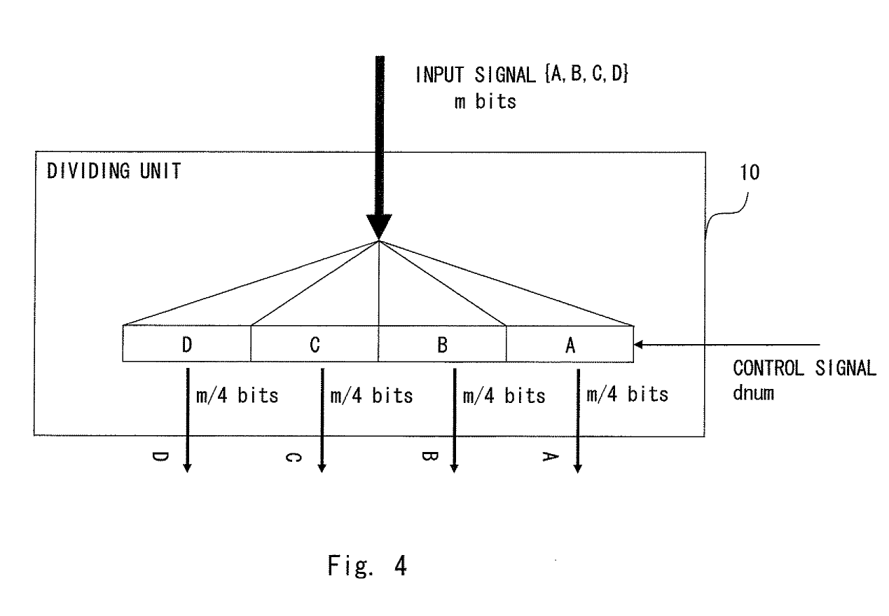

In this specification, the same components with the same name denoted by different reference numerals, e.g., the plurality of dividing units denoted by dividing units 10 to 14, have the similar function. Further, each of the coupling units 20 to 23 and the comparison/selection units 30 to 33 also has the similar function as long as the components have the same name. The same thing can be said for selection units 40 to 44 and a comparison unit 50, which will be described later. In the following description, each component may be described using one reference numeral (e.g., dividing unit 10 in FIG. 4).

With reference to FIG. 4, the dividing unit 10 will be described. The dividing unit 10 divides m-bit (m is an integer larger than zero) input data into dnum pieces of (m/dnum)-bit data based on a control signal dnum (dnum is an integer larger than zero). The control signal dnum indicates the number of data items after division. FIG. 4 shows a case in which the control signal dnum is 4, and the dividing unit 10 divides m-bit input data into four pieces of (m/4)-bit data.

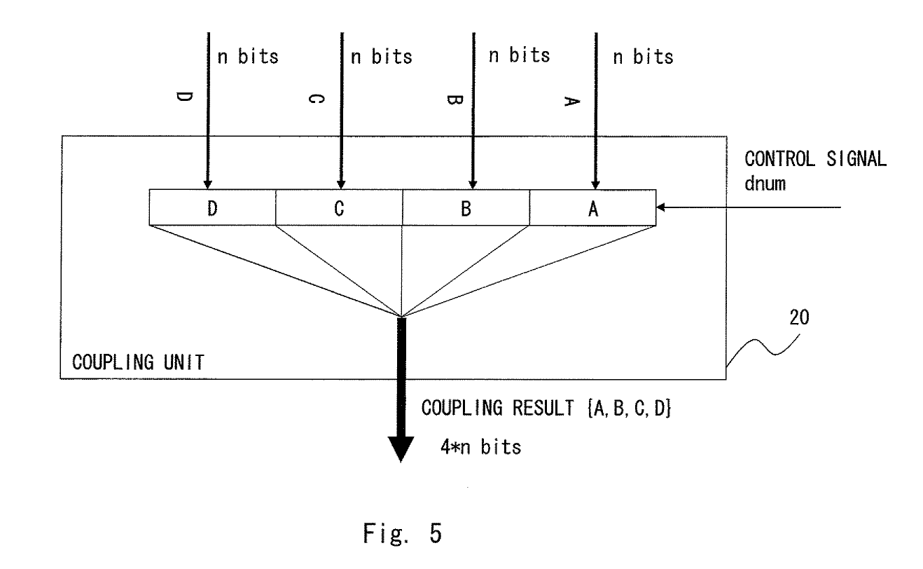

With reference to FIG. 5, the coupling unit 20 will be described. The coupling unit 20 couples dnum pieces of n-bit (n is an integer larger than zero) input data to (dnum*n)-bit data based on the control signal dnum. The control signal dnum indicates the number of data items before coupling. In FIG. 5, the control signal dnum is 4, and the coupling unit 20 couples four pieces of n-bit input data into one (4*n)-bit data.

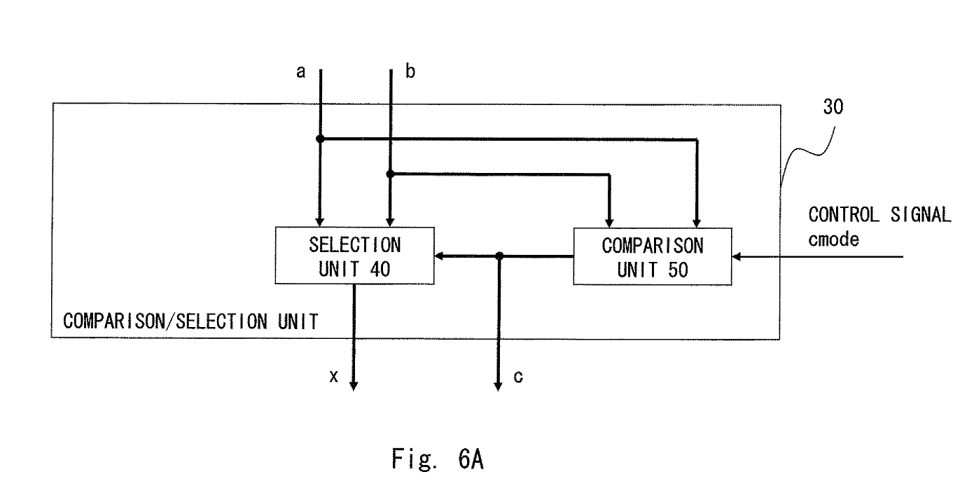

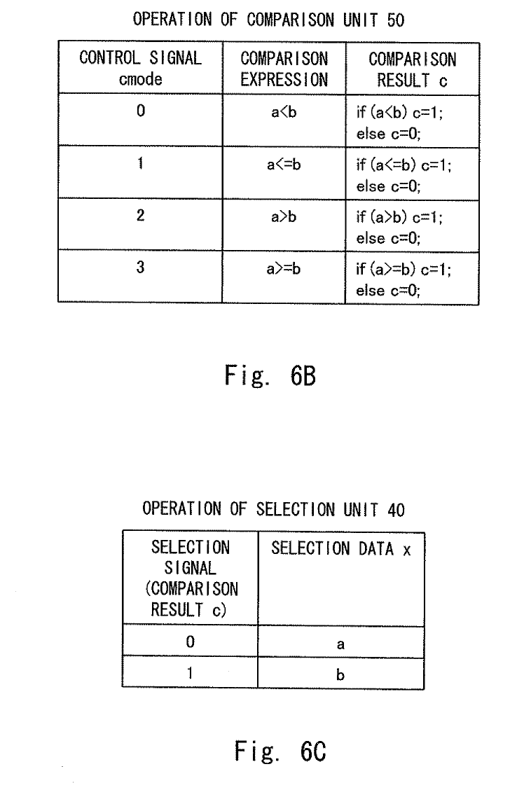

With reference to FIGS. 6A, 6B, and 6C, the comparison/selection unit 30 will be described. As shown in FIG. 6A, the comparison/selection unit 30 includes a selection unit 40 and a comparison unit 50. The comparison/selection unit 30 receives a control signal cmode, data a, and data b. The comparison/selection unit 30 outputs selection data x and a comparison result c. The comparison unit 50 compares the data a with the data b based on the control signal cmode, to output the comparison result c.

The relation among the control signal cmode, a comparison expression, and the comparison result is as shown in the table of FIG. 6B. The control signal output to the comparison unit 50 represents the comparison expression. The comparison unit 50 compares the data a with the data b using the comparison expression according to the control signal. There are four kinds of comparison expressions: a<b, a<=b, a>b, and a>=b. When the comparison expression is satisfied, the comparison result c is one; otherwise the comparison result c is zero. The relation among the control signal cmode, the data a and b, and the comparison result c is expressed as c=compare(cmode, a, b) using function compare( ). In this way, the operation of the comparison unit 50 can be expressed using function compare( ).

The selection unit 40 selects one of the data a and the data b using the comparison result c supplied from the comparison unit 50 as the selection signal, and outputs the selected one as the selection data x. The relation between the selection signal (comparison result c) and the selection data x is as shown in the table of FIG. 6C. The selection unit 40 selects one of the input signals a and b according to the selection signal and outputs the selected one. Specifically, when the selection signal c is zero, the data a is selected; otherwise the data b is selected. The selected data is denoted by selection data x. The relation between the selection signal c and the data a and b is expressed as x=select(c, a, b) using the function select ( ). In this way, the operation of the selection unit 40 can be expressed using function select( ).

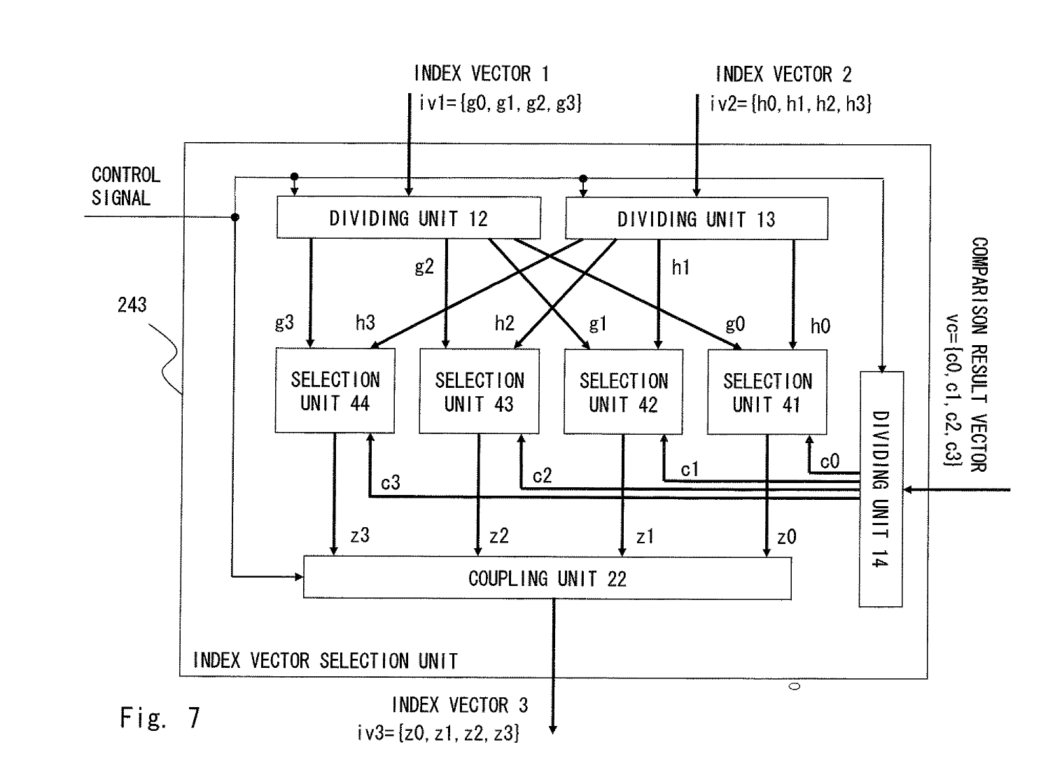

With reference to FIG. 7, the index vector selection unit 243 will be described. The index vector selection unit 243 includes three dividing units 12 to 14, a plurality of selection units 41 to 44, and one coupling unit 22. FIG. 7 shows a case in which the number of selection units is four. The index vector selection unit 243 receives the control signal, the index vector 1, the index vector 2, and the comparison result vector. The index vector selection unit 243 outputs the index vector 3.

The dividing unit (first index dividing unit) 12 shown in FIG. 7 divides the index vector 1 into a plurality of elements based on the control signal. Similarly, the dividing unit (second index dividing unit) 13 shown in FIG. 7 and the dividing unit (comparison result dividing unit) 14 shown in FIG. 7 respectively divide the index vector 2 and the comparison result vector into a plurality of elements based on the control signal. Each of the selection units 41 to 44 selects one of an element g supplied from the dividing unit 12 and an element h supplied from the dividing unit 13 using the element c (comparison result c) supplied from the dividing unit 14 as a selection signal, and outputs the selected one as an element z. The coupling unit 22 couples the elements z supplied from the plurality of selection units 41 to 44 to one vector based on the control signal, and outputs it as the index vector 3.

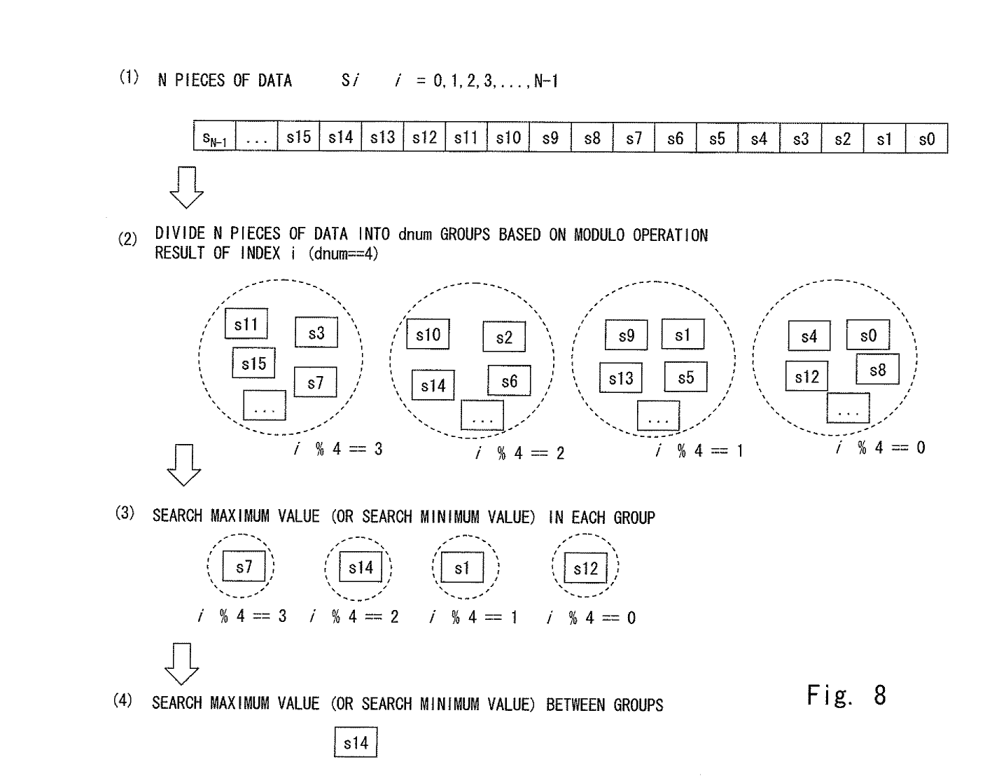

Next, an operation of the first exemplary embodiment will be described with reference to the drawings. In the following description, processing for searching a maximum value or a minimum value and its index from among a plurality of data items is referred to as “processing for searching a maximum value or a minimum value”. FIG. 8 shows a concept of the processing for searching a maximum value or a minimum value.

First, as shown in (1), N (N is an integer larger than zero) pieces of data are denoted by S0, S1, S2, . . . , and S_{N-1}. Next, as shown in (2), the N pieces of data are divided into dnum groups. The N pieces of data are divided so that the remainder obtained by dividing the index of the data by dnum becomes equal. Note that dnum is any positive integer, and is preferably a power of two so as to facilitate implementation.

Next, as shown in (3), the maximum value or the minimum value and its index in each group are searched. This results in selection of one piece of data and its index for each group. Last, as shown in (4), the maximum value or the minimum value and its index are searched from the dnum pieces of selected data. According to the concept shown in FIG. 8, dnum number of search processing can be executed in parallel in (3). According to the first exemplary embodiment of the present invention, the processing for searching the maximum value or the minimum value is executed based on the concept shown in FIG. 8.

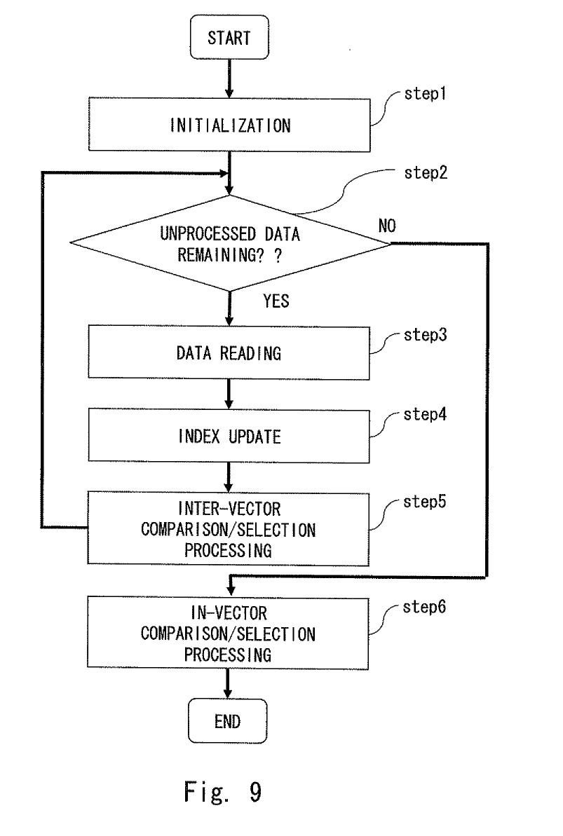

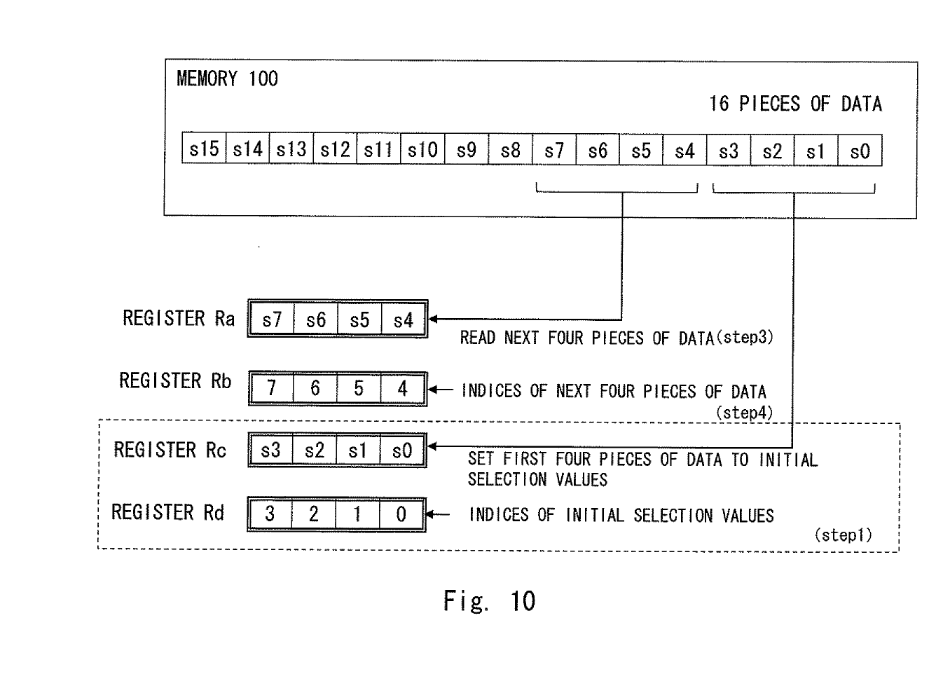

FIG. 9 is a flow chart for executing the processing for searching the maximum value or the minimum value according to the representative exemplary embodiment of the present invention based on the concept shown in FIG. 8. This flow chart shows the processing contents of the program for the processor 200 of FIG. 1. The program is stored in the memory 100 of FIG. 1. The processor 200 executes the program, to search the maximum value or the minimum value and its index from among the plurality of data items. The plurality of data items are stored in the memory 100.

The processing for searching the maximum value or the minimum value according to the first exemplary embodiment includes six steps.

Step 1 performs initialization of search processing.

Step 2 searches whether there is unprocessed data.

Step 3 reads data.

Step 4 updates the index of the data.

Step 5 compares two vectors for each corresponding element, to select the element which is larger or smaller. Selection of the element is accompanied by selection of the index corresponding to the element.

Steps 2 to 5 are repeated until all the data are processed. The repeat from step 2 to step 5 corresponds to (2) and (3) in FIG. 8.

The vectors compared in step 5 are divided into groups in a position in the register of each element, and comparison and selection are executed for each group. The selected elements are stored in the register again to be used in step 5 next time. Upon completion of the repeat from step 2 to step 5, the maximum value or the minimum value of each group selected by step 5 is coupled as one vector, which is stored in the register. This is the state in which (3) in FIG. 8 is completed.

Step 6 that is executed last selects the maximum value or the minimum value from all the elements of one vector. Selection of the maximum value or the minimum value is accompanied by selection of the index corresponding to its value. Step 6 corresponds to (4) in FIG. 8.

Execution of steps 1 to 6 gives the maximum value or the minimum value and its index from among the plurality of data items.

In the following description, for the sake of simplicity of description, it is assumed that dnum in the concept of FIG. 9 is 4, the number of data items N is 16, and each data is an integer of 16 bits. Assume that the register bank 230 of the processor 200 in FIG. 1 includes a plurality of 64-bit registers. The four 64-bit registers of the register bank 230 are denoted by registers Ra, Rb, Rc, and Rd. The dnum pieces of data stored in the registers are called a vector. Each element of the vector is data. In the following description of operation and drawings (FIGS. 10, 11, and 13), step 1 to step 6 correspond to the processing denoted by the same step number shown in FIG. 9.

With reference to FIG. 10, step 1 according to the first exemplary embodiment will be described. In step 1, the processor 200 stores dnum pieces of initial selection values (initial values of the selection values) into the register Rc of the register bank 230, and stores dnum pieces of indices corresponding to them into the register Rd. In FIG. 10, the dnum pieces of initial selection values are s0, s1, s2, and s3 stored in the memory 100, the indices of which being 0, 1, 2, and 3.

In step 2 according to the first exemplary embodiment, the processor 200 calculates the number of unprocessed data items. When the number is larger than zero, the process goes to step 3; otherwise the process goes to step 6. In FIG. 10, in the state immediately after step 1, the number of unprocessed data items is N-dnum since dnum pieces of data among N pieces of data are used as the initial selection values. Since it is assumed that the number of data items N is 16 and the division number is dnum, N−dnum=16−4=12, which means there remains unprocessed data.

In step 3 according to the first exemplary embodiment, the processor 200 reads the next dnum pieces of data from the memory 100, and stores them in the register Ra. In FIG. 10, the next dnum pieces of data are s4, s5, s6, and s7.

In step 4 according to the first exemplary embodiment, the processor 200 stores the indices of the next dnum pieces of data in the register Rb. In FIG. 10, the next dnum pieces of data are s4, s5, s6, and s7, and thus the indices thereof are 4, 5, 6, and 7.

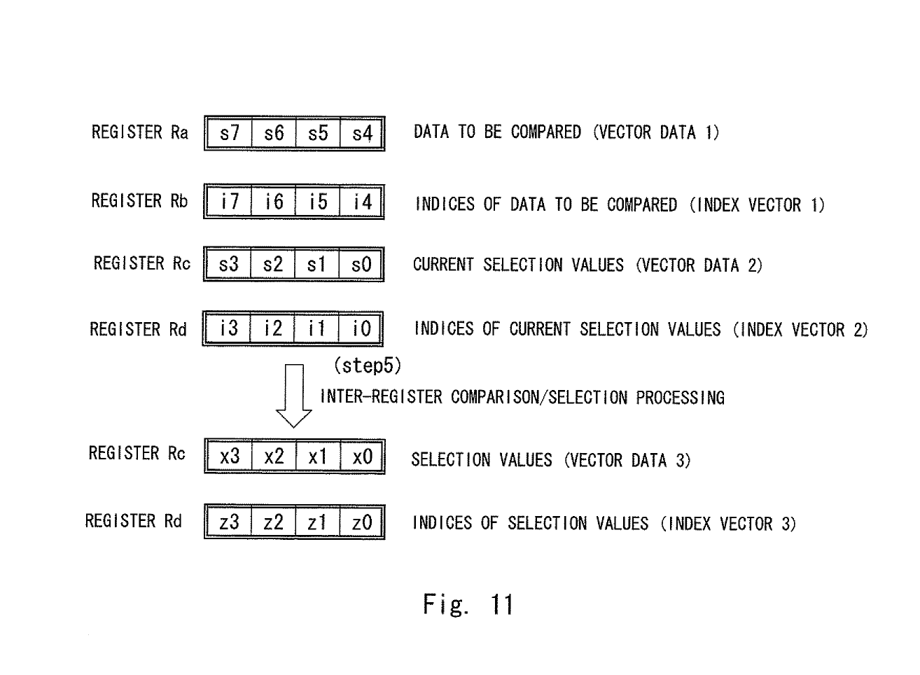

Step S5 according to the first exemplary embodiment will be described with reference to FIG. 11. In step 5, the processor 200 operates the parallel comparison/selection operation unit 240 shown in FIG. 2, to perform inter-vector comparison/selection processing. The inter-vector comparison/selection processing is the processing for comparing two pieces of vector data for each corresponding element, selects the element which is larger or smaller, and selects the index corresponding to the selected element. The two pieces of vector data are denoted by vector data 1 and vector data 2, and the index vectors corresponding to them are denoted by index vector 1 and index vector 2, respectively. In FIG. 11, the vector data 1, the index vector 1, the vector data 2, and the index vector 2 are stored in the registers Ra, Rb, Rc, and Rd, respectively.

In step 5, the processor 200 reads the instruction for operating the parallel comparison/selection operation unit 240 from the memory 100. The instruction decoder 210 decodes the instruction, and transmits information including an operand or an instruction code of its instruction to the parallel comparison/selection operation unit 240 as the control signal. Upon receiving the control signal from the instruction decoder 210, the parallel comparison/selection operation unit 240 reads out the vector data 1, the index vector 1, the vector data 2, and the index vector 2 from the registers Ra, Rb, Rc, and Rd, operates the vector comparison/selection unit 242 and the index vector selection unit 243, and outputs the vector data 3 and the index vector 3 to the registers Rc and Rd, respectively.

Now, an operation of the parallel comparison/selection operation unit 240 will be described in detail using the functional notation and the data shown in FIG. 11. First, the operation of the vector comparison/selection unit 242 is described using FIGS. 3, 6A, 6B, 6C, and 11.

The dividing units 10 and 12 (FIG. 3) divide the vector data 1 and the vector data 2 for each element. In FIG. 11, the dividing unit 10 divides the vector data 1 into each element of s4 to s7, and the dividing unit 11 divides the vector data 2 into each element of s0 to s3.

Subsequently, the plurality of comparison/selection units 30 to 33 (FIG. 3) execute comparison/selection processing for each element. The comparison unit 50 (FIG. 6A) included in each of the plurality of comparison/selection units 30 to 33 compares the data stored in the register Ra with the data stored in the register Rc by function compare( ). Specifically, the comparison unit 50 included in each of the plurality of comparison/selection units 30 to 33 compares the data using the following functions, where cmode indicates the control signal supplied to each of the comparison/selection units 30 to 33.

c0=compare(cmode,s0,s4)
c1=compare(cmode,s1,s5)
c2=compare(cmode,s2,s6)
c3=compare(cmode,s3,s7)

Subsequently, the selection unit 40 included in each of the plurality of comparison/selection units 30 to 33 selects appropriate data from the registers Ra and Rc with the function select ( ) using the comparison result compared by the comparison unit 50. Specifically, the selection units 40 select appropriate data using the following functions.

x0=select(c0,s0,s4)
x4=select(c1,s1,s5)
x2=select(c2,s2,s6)
x3=select(c3,s3,s7)

Now, c0 to c3, and x0 to x3 correspond to data having the same signs in FIG. 3. The coupling unit 20 couples x0 to x3 to generate the vector data 3. The coupling unit 21 couples c0 to c3 to generate the comparison result vector, which is output to the index vector selection unit 243.

Next, with reference to FIGS. 7 and 11, the operation of the index vector selection unit 243 will be described.

The dividing units 12 and 13 (FIG. 7) divide the index vector 1 and the index vector 2 for each element (for each index). In FIG. 11, the dividing unit 12 divides the vector data 1 into each element of i4 to i7, and the dividing unit 13 divides the vector data 2 into each element of i0 to i3. The dividing unit 14 divides the comparison result vector into each element of c0 to c3.

The selection units 41 to 44 (FIG. 7) select appropriate data from the registers Rb and Rd as is similar to the selection unit 40 (FIG. 6A) of the vector comparison/selection unit 242. Specifically, the selection units 41 to 44 select appropriate data using the following functions.

z0=select(c0,i0,i4)
z1=select(c1,i1,i5)
z2=select(c2,i2,i6)
z3=select(c3,i3,i7)

Note that z0 to z3 correspond to data having the same signs as in FIG. 7.

The coupling unit 22 couples z0 to z3, to generate the index vector 3.

As stated above, the vector data 3 generated by the vector comparison/selection unit 242 is stored in the register Rc. The index vector 3 generated by the index vector selection unit 243 is stored in the register Rd.

In the first exemplary embodiment, the vector data 3 and the index vector 3 are stored in the register Rc and the register Rd. Accordingly, as shown in FIG. 11, the vector data read out in the register Ra is called data to be compared, and the data set in the register Rc is called current selection values.

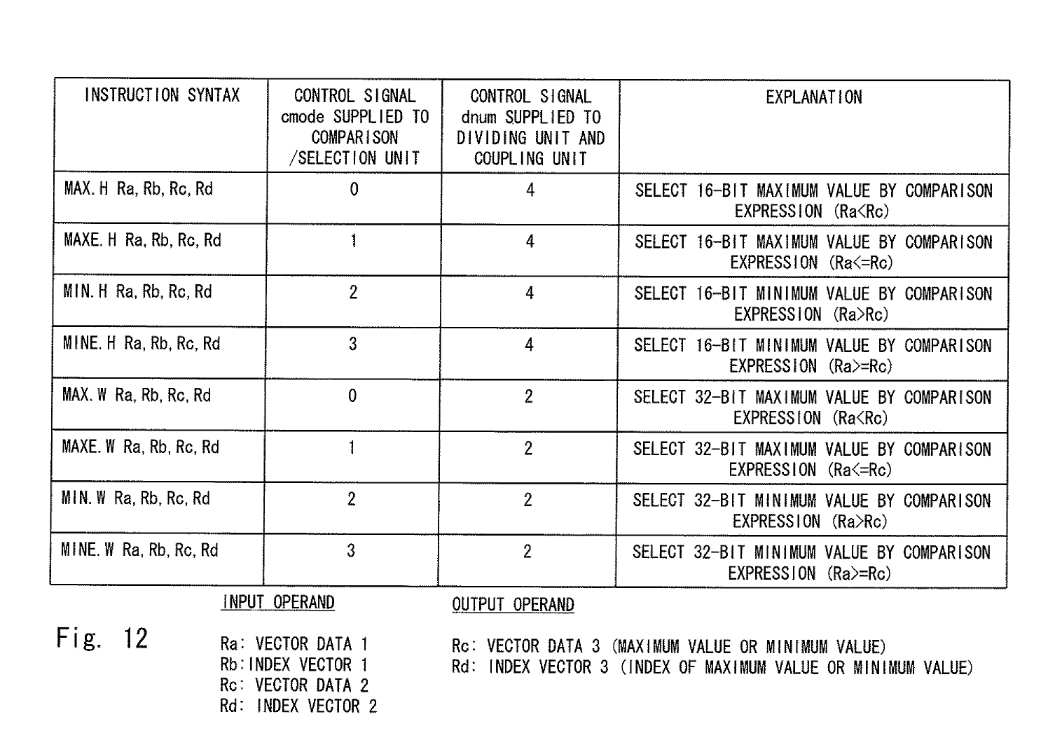

FIG. 12 shows instructions available for operating the parallel comparison/selection operation unit 240 in step 5. FIG. 12 shows syntax of eight instructions, two control signals transmitted by the instruction decoder 210 to the parallel comparison/selection operation unit 240 according to its instruction, and explanation of the instructions. The two control signals are the control signal cmode transmitted to the comparison/selection units 30 to 33 in the parallel comparison/selection operation unit 240, and the control signal dnum transmitted to the dividing unit 10 and the coupling unit 20 in the parallel comparison/selection operation unit 240.

For example, the instruction of MAX.H compares 16-bit values using a comparison expression (Ra<Rc) to select the larger value. The value of cmode of the MAX.H instruction is zero. According to FIG. 6B, cmode=0 means comparison operation “<”. The value of dnum of the MAX.H instruction is four. Note that dnum represents the number of data items after dividing processing or before coupling processing.

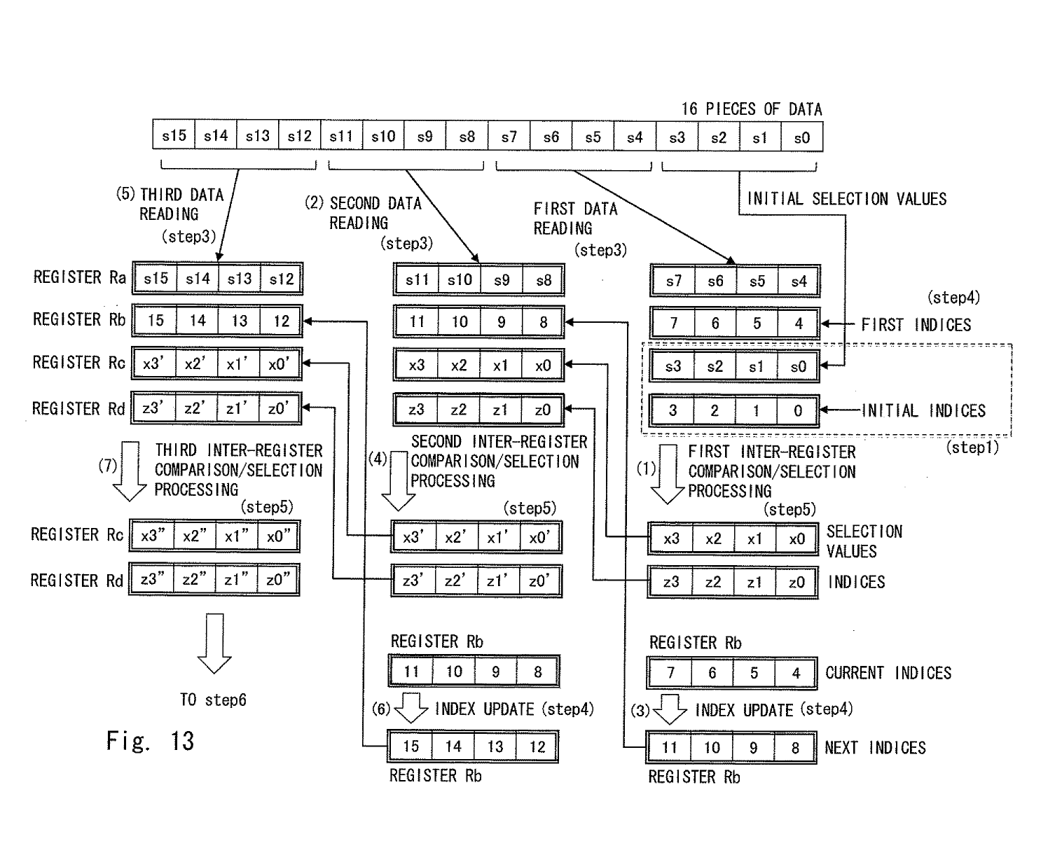

FIG. 13 shows a state in which the maximum value or the minimum value and its index are obtained from 16 pieces of 16-bit data. The processing starts from the top right in FIG. 13.

In step 1, the processor 200 stores the vector data of the initial selection values and the index vectors (initial indices) corresponding to the vector data in the registers Rc and Rd, respectively.

In step 2 (not shown in FIG. 13), the processor 200 moves to step 3 since there are 12 unprocessed data.

In step 3, the processor 200 reads four pieces of data to be compared into the register Ra.

In step 4, the processor 200 stores indices of four pieces of data to be compared into the register Rb.

In step 5, the processor 200 executes first inter-register comparison/selection processing using registers Ra, Rb, Rc, and Rd. The data and the indices selected by the first inter-register comparison/selection processing are stored in the registers Rc and Rd, respectively. This first inter-register comparison/selection processing is numbered (1).

The following processing proceeds as shown below. Step 2 is omitted.

(2) step 3: second data reading
(3) step 4: index update
(4) step 5: second inter-register comparison/selection processing
(5) step 3: third data reading
(6) step 4: index update
(7) step 5: third inter-register comparison/selection processing

In step 3 of (2), the processor 200 reads new four pieces of data into the register Ra.

In step 4 of (3), the processor 200 calculates indices of new four pieces of data using the indices of the register Rb, and stores them in the register Rb. The method of calculating the index update is to add four to each element of the register Rb.

In step 5 of (4), the processor 200 executes second inter-register comparison/selection processing.

Similarly, (5), (6), and (7) are executed.

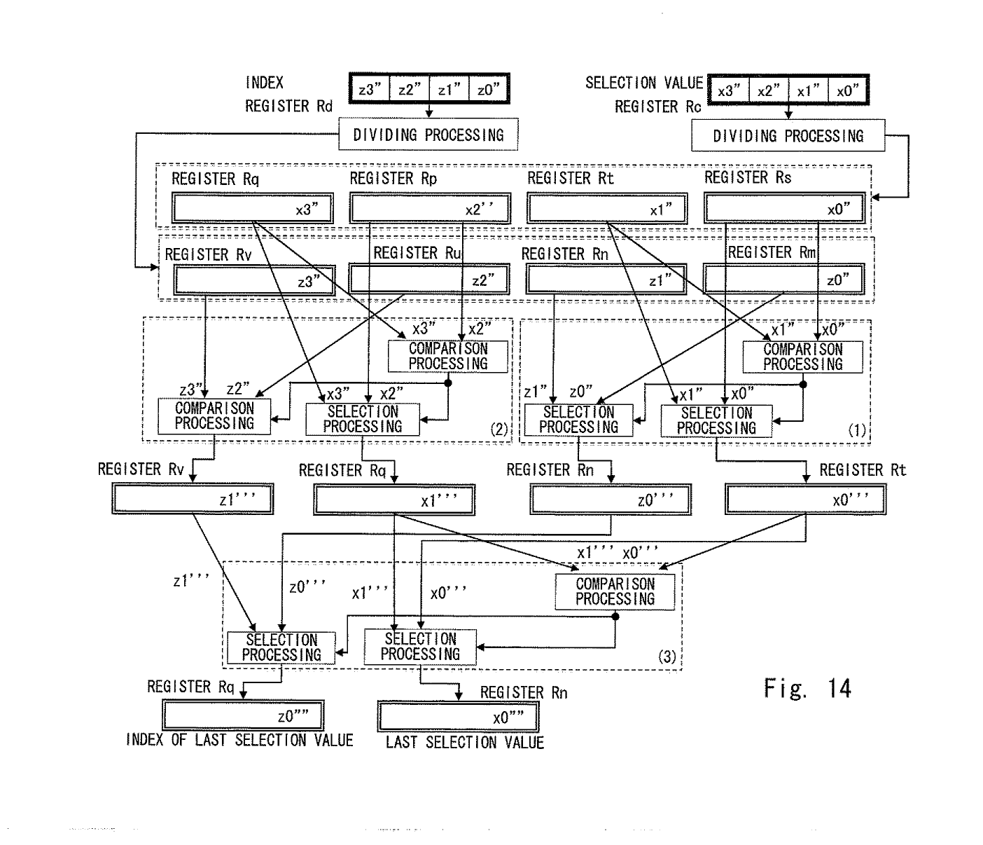

Step S6 will be described with reference to FIG. 14. Step 6 searches the maximum value or the minimum value from all the elements of the vector stored in one register and retrieves the index corresponding to its value from another register.

Whether the processor 200 searches the maximum value or the minimum value in step 6 is determined by the program stored in the memory 100.

In FIG. 14, the selection values selected from four groups are stored in the register Rc, and the indices of the selection values selected from four groups are stored in the register Rd.

In step 6, the processor 200 stores four selection values x0″, x1″, x2″, x3″ stored in the register Rc, and the four indices z0″, z1″, z2″, z3″ stored in the register Rd in separate registers.

The processor 200 executes comparison/selection processing three times to further select one value from the four selection values.

In the first comparison/selection processing, the processor 200 compares x0″ with x1″, and selects the value that satisfies the comparison condition. The comparison condition is assumed to be described in the program of step 6.

For example, when the comparison condition is comparison operation “<”, x1″ is selected if x0″<x1″ is true; otherwise x0″ is selected. The comparison condition may be comparison operation “<”, “<=”, “>”, “>=”, for example.

The processor 200 selects one index of z0″ and z1″ based on the comparison result of x0″ with x1″.

For example, if x0″<x1″ is true, z0″ is selected; otherwise z1″ is selected.

The comparison/selection processing are executed three times in step 6, and the same comparison condition is applied to any comparison/selection processing.

In the similar way, in the first comparison/selection processing, the processor 200 compares x2″ with x3″, and selects the value which satisfies the comparison condition.

The processor 200 selects one index of z2″ or z3″ based on the comparison result of x2″ with x3″.

The values selected by the first and second comparison/selection processing are denoted by x0′″ and x1′″, and the corresponding indices of them are denoted by z0″″ and z1′″. The processor 200 executes third comparison/selection processing using these values and indices.

The processor 200 compares x0′″ with x1′″, and selects the value that satisfies the comparison condition.

The processor 200 selects one index of z0′″ and z1′″ based on the comparison result of x0′″ with x1′″.

The value and the index selected in the third comparison/selection processing are denoted by x0″″ and z0″″.

Note that x0″″ is the maximum value or the minimum value that is selected by the processor 200 from x0″, x1″, x2″, and x3″ in step 6, and is the maximum value of all the data. Further, z0″″ is the index of x0″″.

As described above, the parallel comparison/selection operation unit according to the first exemplary embodiment receives the vector data 1, the vector data 2, the index vector 1 including the index of each element of the vector data 1, and the index vector 2 including the index of each element of the vector data 2. The parallel comparison/selection operation unit compares each element of the vector data 1 and the vector data 2, to generate the vector data 3 by selecting one of the vector data 1 and the vector data 2 for each element based on the comparison result. Further, the parallel comparison/selection operation unit selects one of the index vector 1 and the index vector 2 for each element (for each index) based on the comparison result, to generate a plurality of selected elements as the index vector 3. The parallel comparison/selection operation unit then outputs the vector data 3 and the index vector 3.

According to the parallel comparison/selection operation unit of the first exemplary embodiment, it is possible to compare two pieces of vector data for each element, select one element based on the comparison result, and select the index corresponding to the selected element. Further, the processor including the parallel comparison/selection operation unit according to the first exemplary embodiment is able to efficiently execute a search for a maximum value or a minimum value with an index.

Further, the processor includes a parallel comparison/selection operation unit according to the first exemplary embodiment, thereby being capable of efficiently performing inter-vector comparison/selection processing and obtaining the maximum value or the minimum value using the result of the inter-vector comparison/selection processing.

Described in the first exemplary embodiment is a case in which the comparison results output from the comparison/selection units 30 and 31 in the vector comparison/selection unit 242 are output to the index vector selection unit 243 as the comparison result vector which is a set of a plurality of comparison results (FIGS. 2, 3, and 7). It is not limited to this configuration, but a plurality of comparison results may be output from the vector comparison/selection unit 242 to the index vector selection unit 243 as a plurality of selection signals. In this case, the coupling unit 21 (FIG. 3) and the dividing unit 14 (FIG. 7) may be omitted.

Using the comparison result vector allows a flexible response to changes in the number of elements included in the vector. Specifically, there is no need to change the number of selection signals (comparison result vectors) output from the vector comparison/selection unit 242 to the index vector selection unit 243. It is possible to address with the changes in the number of element by changing the number of comparison/selection units in the vector comparison/selection unit 242, the number of selection units in the index vector selection unit 243, related signal lines and the like.

In other words, the use of the dividing unit and the coupling unit can vary the data width of each element of the vector data. For example, it enables processing of the vector data including elements having the data width of 16 bits or processing of the vector data including elements having the data width of 8 bits. However, the data width of all the elements in one vector data needs to be the same. Meanwhile, when the use of the dividing unit and the coupling unit are not used, it is possible to process only the vector data including an element of a predetermined data width. It is impossible to process the vector data including elements having other data width.

### Second Exemplary Embodiment

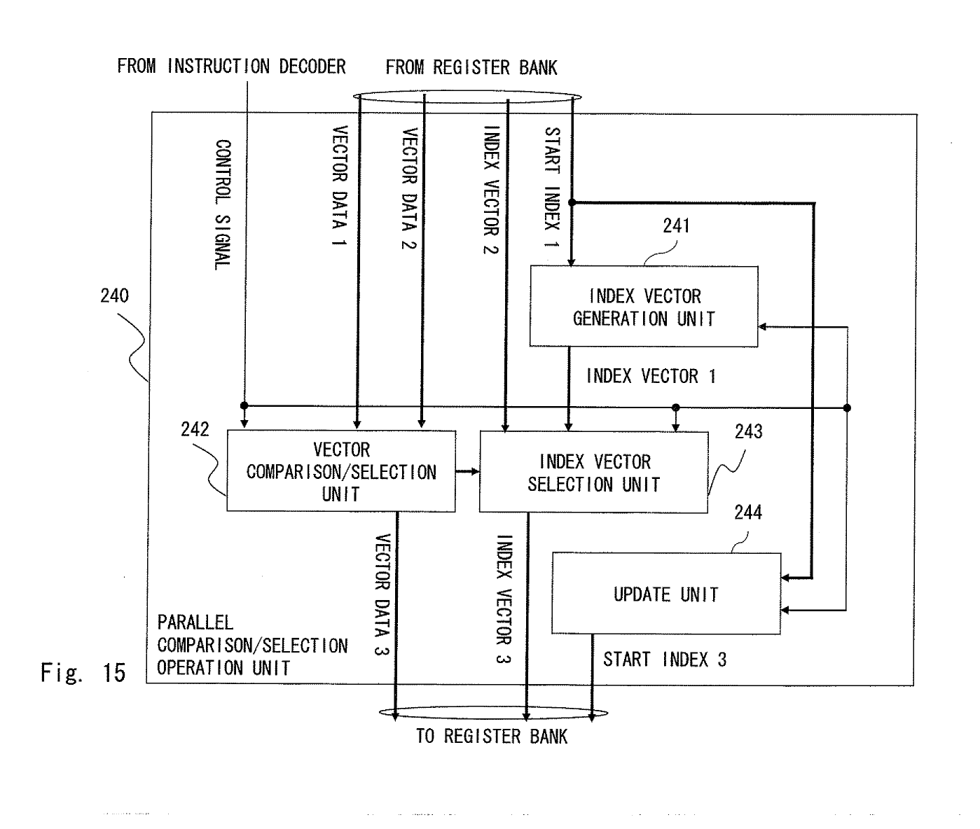

A parallel comparison/selection operation unit 240a according to a second exemplary embodiment will be described with reference to FIG. 15. In the second exemplary embodiment, the processor 200 shown in FIG. 1 uses a parallel comparison/selection operation unit 240a shown in FIG. 15 in place of the parallel comparison/selection operation unit 240. Described in the second exemplary embodiment is a case in which information regarding the index of the vector data 1 (first index information) is used in place of the index vector 1 used in the first exemplary embodiment. Specifically, a case will be described in which an index of the first element (0-th element) of the vector data 1 is used as the first index information. Hereinafter, the index of the first element is called start index 1.

The parallel comparison/selection operation unit 240a according to the second exemplary embodiment includes a vector comparison/selection unit 242, an index vector selection unit 243, an index vector generation unit 241, and an update unit 244.

The parallel comparison/selection operation unit 240a according to the second exemplary embodiment receives a control signal supplied from the instruction decoder 210, and four pieces of data supplied from the register bank 230. The four pieces of data include vector data 1, vector data 2, start index 1, and index vector 2. The parallel comparison/selection operation unit 240a according to the second exemplary embodiment outputs vector data 3 and start index 1.

The first exemplary embodiment and the second exemplary embodiment are different in the following two points. First, the second exemplary embodiment generates the index vector 1 from the start index 1 by the index vector generation unit 241. Second, the second exemplary embodiment changes the value of the start index 1 using the update unit 244 to output the changed value.

The configurations and the operations of the vector comparison/selection unit 242 and the index vector selection unit 243 according to the second exemplary embodiment are similar to those of the first exemplary embodiment.

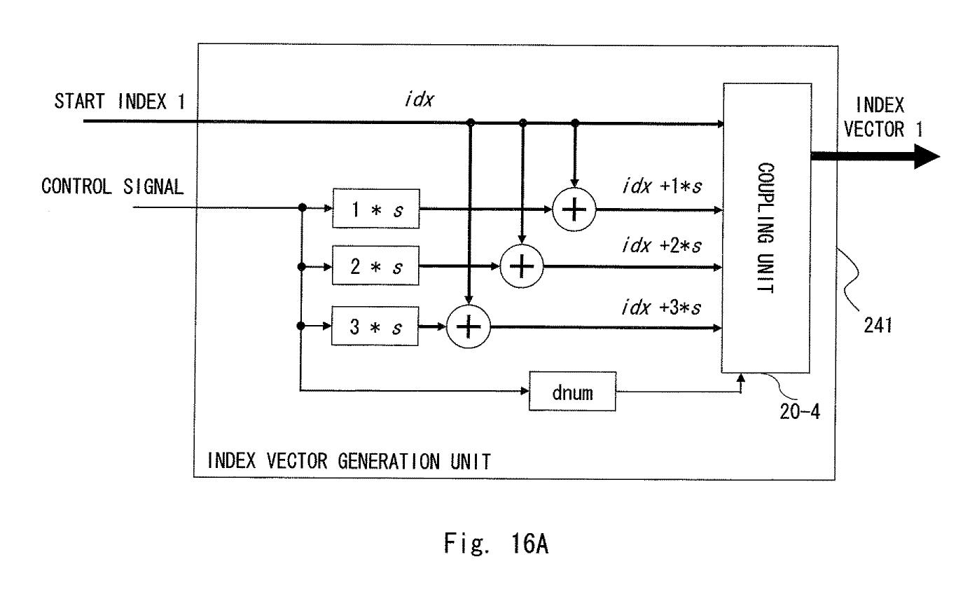

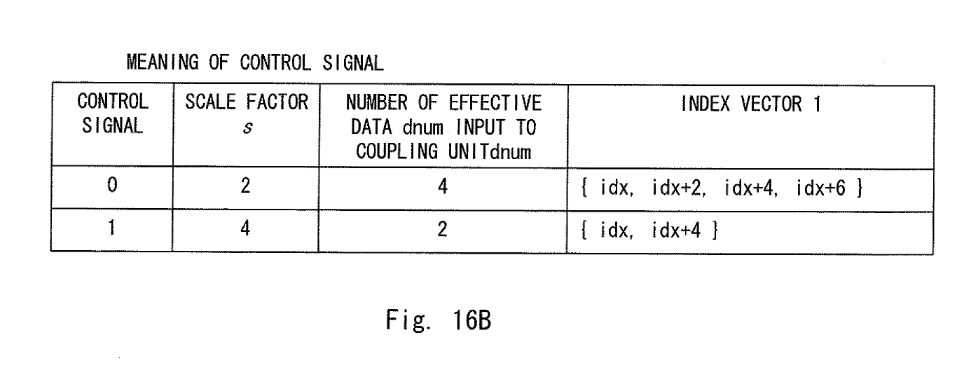

The index vector generation unit 241 will be described with reference to FIGS. 16A and 16B. As shown in FIG. 16A, the index vector generation unit 241 includes a coupling unit 23. The index vector generation unit 241 receives the control signal supplied from the instruction decoder 210 and the start index 1 supplied from the register bank 230. The index vector generation unit 241 outputs the index vector 1.

The index vector generation unit 241 generates the index vector 1 from the start index 1 based on the control signal. The relation among the control signal, the start index 1, and the index vector 1 is as shown in the table of FIG. 16B.

When the start index 1 is idx, the index vector generation unit 241 calculates three pieces of data of idx+1*s, idx+2*s, and idx+3*s, and transmits a total of four pieces of data including idx to the coupling unit 20. Further, the index vector generation unit 241 transmits the signal of dnum to the coupling unit 23 based on the control signal.

Note that s (s is an integer larger than zero) denotes a scale factor, and dnum is a signal indicating the number of data items to be coupled by the coupling unit 20. If the control signal is zero, s is two. In FIG. 16B, if the control signal is one, s is four. If the control signal is zero, the coupling unit 20 couples four pieces of data of idx, idx+2, idx+4, and idx+6, and outputs the coupled data as the index vector 1. If the control signal is one, the coupling unit 20 couples two pieces of data of idx and idx+4, and outputs the coupled data as the index vector 1.

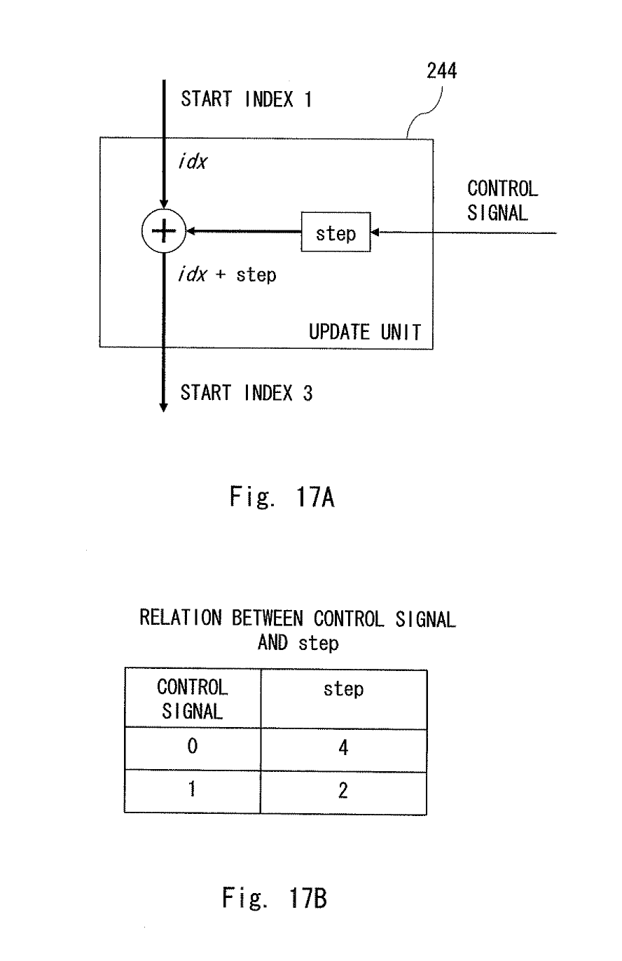

The update unit 244 will be described with reference to FIGS. 17A and 17B. The update unit 244 receives the start index 1 and the control signal. The update unit 244 outputs the start index 1. The update unit 244 increments the start index 1. The increment is indicated by the value of step, which is determined by the control signal. The relation between the control signal and step is shown in the table in FIG. 17B. If the control signal is 0, step is 2. If the control signal is 1, step is 4.

Subsequently, an operation of the second exemplary embodiment will be described with reference to the drawings. In the second exemplary embodiment, the parallel comparison/selection operation unit 240a of the processor 200 is formed as shown in FIG. 15. The second exemplary embodiment searches the maximum value or the minimum value and its index from the plurality of data items based on the concept of FIG. 8 and the flow chart in FIG. 9, as is similar to the first exemplary embodiment.

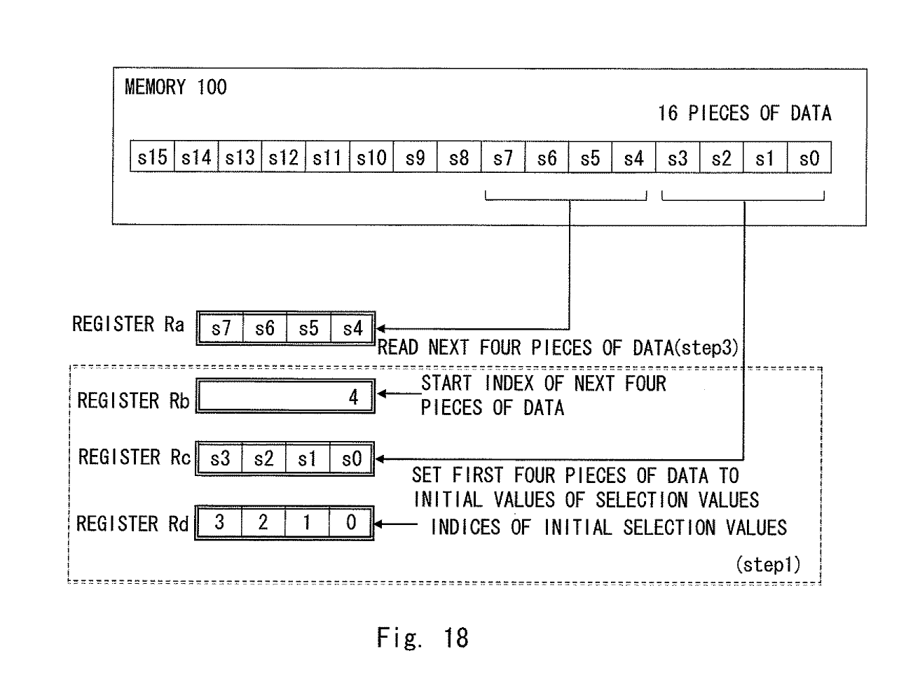

In the following description, for the sake of simplicity, it is assumed that dnum in the concept of FIG. 9 is four, the number of data items N is 16, and each data is an integer of 16 bits. Assume that the register bank 230 of the processor 200 shown in FIG. 1 includes a plurality of 64-bit registers. The four 64-bit registers in the register bank 230 are denoted by registers Ra, Rb, Rc, and Rd. The dnum pieces of data stored in the register is called a vector. Each element of the vector is data. Further, in the following description of operation and drawings (FIGS. 18, 19, and 21), step 1 to step 6 correspond to the processing of the same step number shown in FIG. 9.

Step 1 in the second exemplary embodiment will be described with reference to FIG. 18.

Step 1 according to the second exemplary embodiment is different from step 1 according to the first exemplary embodiment. In step 1, the processor 200 stores dnum pieces of initial selection values to the register Rc of the register bank 230, and dnum pieces of indices corresponding to them to the register Rd. Further, the index of the next dnum pieces of data stored in the register Rc is stored in the register Rb as the start index. Storing the start index into the register Rb is different from step 1 according to the first exemplary embodiment.

In FIG. 18, dnum pieces of initial selection values are s0, s1, s2, and s3 that are stored in the memory 100, the indices of which being 0, 1, 2, and 3. Since the next data is s4, the start index is 4.

Step 2 according to the second exemplary embodiment is totally the same to step 2 according to the first exemplary embodiment. In step 2 according to the second exemplary embodiment, the processor 200 calculates the number of unprocessed data items. If the number of unprocessed data items is larger than zero, the process goes to step 3; otherwise the process goes to step 6.

In FIG. 18, in the state immediately after step 1, the number of pieces of unprocessed data is N-dnum since dnum pieces of data among N pieces of data are used as the initial selection values. Since it is assumed that the number of data items N is 16 and the division number is dnum, N−dnum=16−4=12, which means there remains unprocessed data.

Step 3 according to the second exemplary embodiment is totally the same to step 3 according to the first exemplary embodiment. In step 3 according to the second exemplary embodiment, the processor 200 reads the next dnum pieces of data from the memory 100, and stores them in the register Ra.

In FIG. 18, the next dnum pieces of data are s4, s5, s6, and s7.

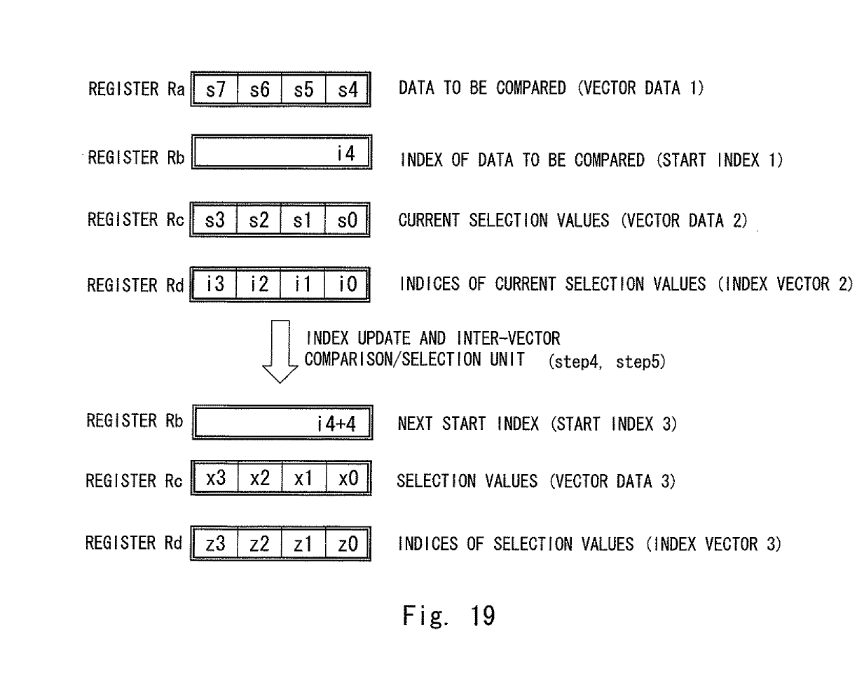

Step 4 and step 5 according to the second exemplary embodiment are executed in parallel. Step 4 and step 5 according to the second exemplary embodiment will be described with reference to FIG. 19. In step 4 and step 5, the processor 200 operates the parallel comparison/selection operation unit 240a shown in FIG. 15 to perform index update and inter-vector comparison/selection processing. In summary, according to the second exemplary embodiment, the parallel comparison/selection operation unit 240a executes step 4 and step 5 in parallel.

The inter-vector comparison/selection processing according to the second exemplary embodiment will be described. The inter-vector comparison/selection processing compares two pieces of vector data for each corresponding element, selects the element which is larger or smaller, and selects the index corresponding to the selected element. This is totally the same to the inter-vector comparison/selection processing according to the first exemplary embodiment. The difference from the first exemplary embodiment is the way of supplying an index of one vector data. In the second exemplary embodiment, the index of the first element of one vector data is stored in the register as the start index. The parallel comparison/selection operation unit 240a shown in FIG. 15 generates all the indices of one vector data from the start index.

The two pieces of vector data are denoted by vector data 1 and vector data 2, the index of the first element of the vector data 1 is denoted by start index 1, and the index vector corresponding to the vector data 2 is denoted by index vector 2. In FIG. 19, the vector data 1, the start index 1, the vector data 2, and the index vector 2 are stored in the registers Ra, Rb, Rc, and Rd, respectively.

In steps 4 and 5, the processor 200 reads the instruction to operate the parallel comparison/selection operation unit 240a shown in FIG. 15 from the memory 100. The instruction decoder 210 decodes this instruction, and transmits information including an operand and an instruction code of this instruction to the parallel comparison/selection operation unit 240a shown in FIG. 15 as the control signal. Upon receiving the control signal from the instruction decoder 210, the parallel comparison/selection operation unit 240a reads out the vector data 1, the start index 1, the vector data 2, and the index vector 2 from the registers Ra, Rb, Rc, and Rd, operates the index vector generation unit 241, the vector comparison/selection unit 242, the index vector selection unit 243, and the update unit 244, and outputs the vector data 3 and the start index 3 to the registers Rc and Rd, respectively.

Now, the operation of step 5 of the parallel comparison/selection operation unit 240a shown in FIG. 15 will be described in detail using the functional notation and the data shown in FIG. 19. Since the operation of the parallel comparison/selection operation unit 240a is similar to that of step 5 of the first exemplary embodiment, description will be made mainly on the functional notation, and description of the other operations will be omitted.

In the vector comparison/selection unit 242, the plurality of comparison/selection units 30 to 33 (FIG. 3) execute comparison/selection processing for each element. Each comparison unit 50 (FIG. 6A) in the plurality of comparison/selection units 30 to 33 compares data stored in the register Ra and the register Rc by function compare( ). Specifically, each comparison unit 50 in the plurality of comparison/selection units 30 to 33 performs comparison using the following functions. Note that cmode indicates the control signal supplied to the comparison/selection units 30 to 33.

c0=compare(cmode, s0, s4)
c1=compare(cmode,s1,s5)
c2=compare(cmode,s2,s6) c3=compare(cmode,s3,s7)

Subsequently, the selection unit 40 included in each of the plurality of comparison/selection units 30 to 33 selects appropriate data from the registers Ra and Rc with the function select ( ) using the comparison result compared by the comparison unit 50. Specifically, the selection units 40 select appropriate data using the following functions.

x0=select(c0,s0,s4)
x1=select(c1,s1,s5)
x2=select(c2,s2,s6)
x3=select(c3,s3,s7)

Now, c0 to c3, and x0 to x3 correspond to the data having the same signs as in FIG. 3.

The coupling unit 20 couples x0 to x3 to generate the vector data 3. The coupling unit 21 couples c0 to c3 to generate the comparison result vector, which is output to the index vector selection unit 243.

Next, in the index vector selection unit 243, the selection units 41 to 44 (FIG. 7) select appropriate data from the registers Rb and Rd as is similar to the selection unit 40 (FIG. 6A) of the vector comparison/selection unit 242. Specifically, the selection units 41 to 44 select appropriate data using the following functions.

z0=select(c0,i0,i4)
z1=select(c1,i1,i4+1)
z2=select(c2,i2,i4+2)
z3=select(c3,i3,i4+3)

Note that z0 to z3 correspond to the data having the same signs in FIG. 7.

The coupling unit 22 couples z0 to z3 to generate the index vector 3.

As stated above, the vector data 3 generated by the vector comparison/selection unit 242 is stored in the register Rc. Further, the index vector 3 generated by the index vector selection unit 243 is stored in the register Rd.

Note that the contents (processing contents) of the function compare( ) and the function select( ) are the same to those in the first exemplary embodiment.

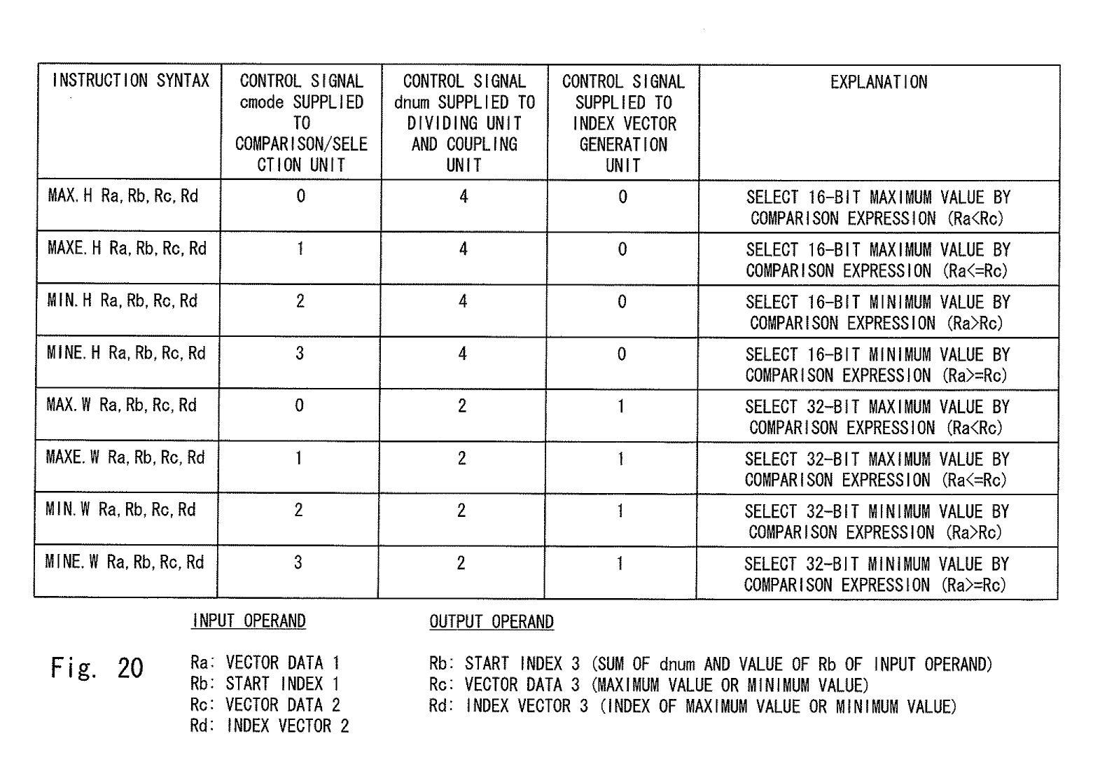

FIG. 20 shows the instructions available for operating the parallel comparison/selection operation unit 240a in steps 4 and 5. FIG. 20 shows syntax of eight instructions, three control signals transmitted by the instruction decoder 210 to the parallel comparison/selection operation unit 240a in FIG. 15 according to this instruction, and explanation of the instruction. The three control signals are the control signal cmode transmitted to the comparison/selection units 30 to 33 in the parallel comparison/selection operation unit 240a shown in FIG. 15, the control signal dnum transmitted to the dividing unit 10 and the coupling unit 20 in the parallel comparison/selection operation unit 240a shown in FIG. 15, and the control signal supplied to the index vector generation unit 241 of the parallel comparison/selection operation unit 240a shown in FIG. 15.

For example, the instruction of MAX.H shown in FIG. 20 is the instruction to compare 16-bit value using the comparison expression (Ra<Rc), select the larger value based on the comparison result, and add four to the start index. The value of cmode in the MAX.H instruction is zero. According to FIG. 6B, cmode=0 indicates comparison operation “<”. The value of dnum in the MAX.H instruction is four. Note that dnum denotes the number of data items after the dividing processing or the coupling processing. The control signal supplied to the index vector generation unit 241 in the MAX.H instruction is zero. This means adding four to the start index 1.

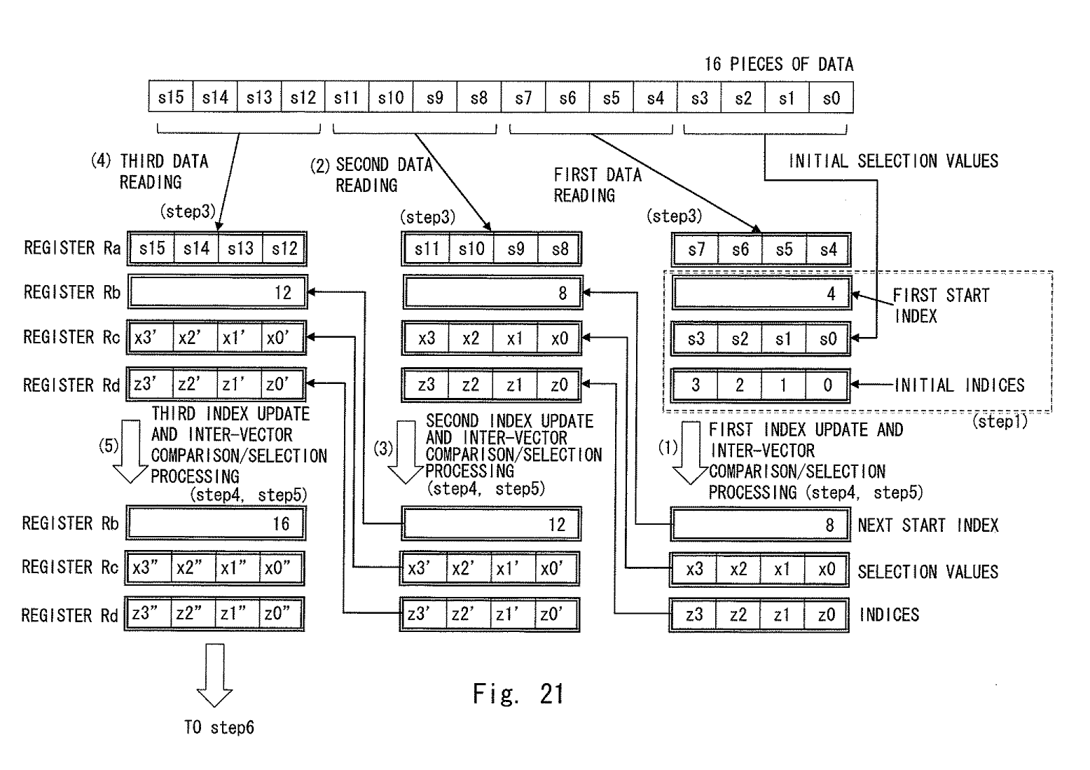

FIG. 21 shows a state in which the maximum value or the minimum value and its index are obtained from 16 pieces of 16-bit data. The processing starts from the top right of FIG. 21.

In step 1, the processor 200 stores the vector data of the initial selection values and the corresponding index vectors (initial indices) in the registers Rc and Rd, respectively, and stores the first start index in the register Rb.

In step 2 (not shown in FIG. 21), the processor 200 moves to step 3 since there are 12 unprocessed data.

In step 3, the processor 200 reads four pieces of data that are to be compared in the register Ra.

In steps 4 and 5, the processor 200 executes the first index update and inter-register comparison/selection processing using the registers Ra, Rb, Rc, and Rd. The start index updated by the first index update is stored in the register Rb. The data and the indices selected by the first inter-register comparison/selection processing are stored in the registers Rc and Rd, respectively. This first index update and inter-register comparison/selection processing is numbered as (1).

The following processing is as shown below. Step 2 is omitted.

(2) step 3: second data reading
(3) steps 4 and 5: second index update and inter-register comparison/selection processing
(4) step 3: third data reading
(5) steps 4 and 5: third index update and inter-register comparison/selection processing

In step 3 of (2), the processor 200 reads new four pieces of data into the register Ra.

In steps 4 and 5 of (3), the processor 200 executes second index update and inter-register comparison/selection processing.

In the similar way, (4) and (5) are executed.

Step 6 is executed after (5) shown in FIG. 21. Step 6 according to the second exemplary embodiment is totally the same to step 6 according to the first exemplary embodiment.

In step 6, the processor 200 searches the maximum value or the minimum value from all the elements of the vector stored in one register, and retrieves the index corresponding to this value from another register.

Execution of step 6 gives the maximum value or the minimum value and its index of all the data.

As described above, the parallel comparison/selection operation unit according to the second exemplary embodiment receives the vector data 1, the vector data 2, the start index 1 indicating the index of the first element of the vector data 1, and the index vector 2 including the index of each element of the vector data 2. The parallel comparison/selection operation unit compares each element of the vector data 1 with each element of the vector data 2, to generate the vector data 3 by selecting any of the vector data 1 and the vector data 2 for each element based on the comparison result. Further, the parallel comparison/selection operation unit generates the index of another element of the vector data 1 based on the start index 1, sets the generated index and the start index 1 to the index vector 1, selects one of the index vector 1 and the index vector 2 for each element based on the comparison result, generates the plurality of selected elements as the index vector 3, and calculates the sum of the start index 1 and the number of elements of the vector data 1 as the start index 3. The parallel comparison/selection operation unit outputs the vector data 3, the index vector 3, and the start index 3.

According to the parallel comparison/selection operation unit according to the second exemplary embodiment, the following effects can be obtained in addition to the effects obtained in the first exemplary embodiment.

First, the use of the start index reduces the capacitance of the register holding the index vectors. Specifically, the capacitance of the register bank 230 shown in FIG. 1 can be reduced. This is because, while the same number of indices as the elements are held as the indices of data to be compared in the first exemplary embodiment, the number of indices can be reduced to one start index in the second exemplary embodiment.

Next, providing the update unit reduces processing time. In the first exemplary embodiment, the index is updated by the processor 200 executing the instruction (step 4 in FIG. 8). In the second exemplary embodiment, the index is updated by the update index in the parallel comparison/selection unit. In short, a hardware executes the update. Accordingly, the number of instructions executed by the processor 200 can be reduced. Thus, the whole processing time can be reduced.

As stated above, according to one aspect of an exemplary embodiment of the present invention, it is possible to provide a parallel comparison/selection operation apparatus to make a search for a maximum value or a search for a minimum value with an index. The parallel comparison/selection operation apparatus and the parallel comparison/selection operation method are capable of comparing two pieces of vector data for each element to select any of the elements based on the comparison result, and are further capable of selecting any of the indices corresponding to the two pieces of vector data for each element based on the comparison result. Further, a processor including this parallel comparison/selection operation apparatus is capable of efficiently executing a search for a maximum value or a search for a minimum value with an index.

According to one aspect of an exemplary embodiment of the present invention, it is possible to efficiently search a maximum value or a minimum value and the corresponding index of a vector including a plurality of elements using a plurality of comparison operation units each having two inputs.

Specifically, a plurality of elements are read into a register for comparison. This enhances the efficiency for reading the plurality of elements of a vector from the register.

Further, a plurality of comparison operation units each comparing two values are provided. A plurality of comparison operation units each having two inputs are used to compare each element of a vector in parallel, thereby searching a maximum value or a minimum value of a vector. The processing delay can be reduced by using a plurality of comparison operation units each having two inputs compared with a case in which a comparison operation unit having multiple inputs is used. Also in terms of the manufacturing of circuits, it is easier to manufacture a plurality of comparison operation units each having two inputs than to manufacture a comparison operation unit having multiple inputs. This can reduce the cost as well.

While the present invention has been described with reference to the exemplary embodiments, the present invention is not limited to them. The configurations and the details of the present invention can be variously changed as will be understood by a person skilled in the art within the scope of the present invention.

This application claims the benefit of priority, and incorporates herein by reference in its entirety, the following Japanese Patent Application No. 2009-021199 filed on Feb. 2, 2009.

### INDUSTRIAL APPLICABILITY

The use of the present invention allows efficient search of a maximum value or a minimum value and its index from a plurality of data items. The processing for searching the maximum value or the minimum value is the basic processing that can be broadly used in the area of information processing. Accordingly, the present invention that is capable of efficiently searching the maximum value or the minimum value can be broadly applied to the area of information processing.

### REFERENCE SIGNS LIST

100 MEMORY
200 PROCESSOR
210 INSTRUCTION DECODER
220 INSTRUCTION EXECUTION UNIT
230 REGISTER BANK
240, 240A PARALLEL COMPARISON/SELECTION OPERATION UNIT
241 INDEX VECTOR GENERATION UNIT
242 VECTOR COMPARISON/SELECTION UNIT
243 INDEX VECTOR SELECTION UNIT
244 UPDATE UNIT
10-14 DIVIDING UNIT
20-23 COUPLING UNIT
30-33 COMPARISON/SELECTION UNIT
40-44 SELECTION UNIT
50 COMPARISON UNIT

1. A parallel comparison/selection operation apparatus comprising:
a vector comparison/selection unit that compares an element included in first vector data and a corresponding element included in second vector data for all corresponding elements, using the first vector data including a plurality of elements and second vector data including the same number of elements as the first vector data, selects one of the element of the first vector data and the element of the second vector data based on the comparison result, and generates third vector data including the selected element;
an index vector selection unit that selects one of an element of a first index vector and an element of a second index vector based on the comparison result using the first index vector including an index corresponding to each element included in the first vector data, the second index vector including an index corresponding to each element included in the second vector data, and the comparison result to generate a third index vector including the selected element;
an index vector generation unit that generates the first index vector based on the start index corresponding to the first element of the first vector data to output the first index vector to the index vector selection unit; and
an update unit that calculates the next start index based on the start index.

2. The parallel comparison/selection operation apparatus according to claim 1, wherein the vector comparison/selection unit comprises a plurality of element comparison/selection unit that compares one element included in the first vector data with one element included in the second vector data to select one of the two elements based on the comparison result.

3. The parallel comparison/selection operation apparatus according to claim 2, wherein
the vector comparison/selection unit comprises the same number of the element comparison/selection unit as the number of elements of the first vector data; and
the vector comparison/selection unit further comprises:
a first vector dividing unit that divides the first vector data into a plurality of elements to output the divided plurality of elements to the plurality of element comparison/selection unit;
a second vector dividing unit that divides the second vector data into a plurality of elements to output the divided plurality of elements to the plurality of element comparison/selection unit; and
a vector coupling unit that couples elements selected by the plurality of element comparison/selection unit to generate the third vector data.

4. The parallel comparison/selection operation apparatus according to claim 2, wherein the index vector selection unit comprises a plurality of selection unit that selects one of two indices based on the comparison result generated by the element comparison/selection unit using an index corresponding to one element included in the first vector data and an index corresponding to one element included in the second vector data.

5. The parallel comparison/selection operation apparatus according to claim 4, wherein the index vector selection unit further comprises:
a first index dividing unit that divides the first index vector into a plurality of indices to output the plurality of indices to the plurality of selection unit;
a second index dividing unit that divides the second index vector into a plurality of indices to output the plurality of indices to the plurality of selection unit; and
an index coupling unit that couples indices selected by the plurality of selection unit to generate the third index vector.

6. The parallel comparison/selection operation apparatus according to claim 2, wherein
the vector comparison/selection unit comprises a comparison result coupling unit that couples the comparison result generated by the plurality of element comparison/selection unit to generate a comparison result vector, and
the index vector selection unit comprises a comparison result dividing unit that outputs the plurality of element comparison results included in the comparison result vector to the plurality of selection unit.

7. (canceled)

8. A processor comprising the parallel comparison/selection operation apparatus according to claim 1.

9. A parallel comparison/selection operation method comprising:
comparing an element included in first vector data and a corresponding element included in second vector data for all corresponding elements, using the first vector data including a plurality of elements, the second vector data including the same number of elements as the first vector data, first index information including a start index corresponding to a first element of the first vector data, and a second index vector including an index corresponding to each element included in the second vector data;
selecting one of the element of the first vector data and the element of the second vector data based on the comparison result;
generating third vector data including the selected element;
selecting an index corresponding to each element included in the third vector data based on the comparison result, the first index information, and the second index vector; and
generating a third index vector including selected plurality of indices;
generating a first index vector including an index corresponding to each element of the first vector data based on the start index; and
selecting an index corresponding to each element of the third vector data from the first index vector and the second index vector based on the comparison result.

10-11. (canceled)

12. The parallel comparison/selection operation method according to claim 9, further comprising calculating the next start index based on the start index.

13. The parallel comparison/selection operation apparatus according to claim 3, wherein the index vector selection unit comprises a plurality of selection unit that selects one of two indices based on the comparison result generated by the element comparison/selection unit using an index corresponding to one element included in the first vector data and an index corresponding to one element included in the second vector data.

14. The parallel comparison/selection operation apparatus according to claim 13, wherein the index vector selection unit further comprises:
a first index dividing unit that divides the first index vector into a plurality of indices to output the plurality of indices to the plurality of selection unit;
a second index dividing unit that divides the second index vector into a plurality of indices to output the plurality of indices to the plurality of selection unit; and
an index coupling unit that couples indices selected by the plurality of selection unit to generate the third index vector.

15. The parallel comparison/selection operation apparatus according to claim 3, wherein
the vector comparison/selection unit comprises a comparison result coupling unit that couples the comparison result generated by the plurality of element comparison/selection unit to generate a comparison result vector, and
the index vector selection unit comprises a comparison result dividing unit that outputs the plurality of element comparison results included in the comparison result vector to the plurality of selection unit.

16. The parallel comparison/selection operation apparatus according to claim 4, wherein
the vector comparison/selection unit comprises a comparison result coupling unit that couples the comparison result generated by the plurality of element comparison/selection unit to generate a comparison result vector, and
the index vector selection unit comprises a comparison result dividing unit that outputs the plurality of element comparison results included in the comparison result vector to the plurality of selection unit.

17. The parallel comparison/selection operation apparatus according to claim 5, wherein
the vector comparison/selection unit comprises a comparison result coupling unit that couples the comparison result generated by the plurality of element comparison/selection unit to generate a comparison result vector, and
the index vector selection unit comprises a comparison result dividing unit that outputs the plurality of element comparison results included in the comparison result vector to the plurality of selection unit.
